(19) United States
(12) Patent Application Publication
(10) Pub. No.: US 2019/0302963 A1
(43) Pub. Date: Oct. 3, 2019

(54) HYBRID DEPTH AND INFRARED IMAGE SENSING AND METHOD FOR ENHANCED TOUCH TRACKING ON ORDINARY SURFACES

(71) Applicant: Carnegie Mellon University, Pittsburgh, PA (US)

(72) Inventors: Christopher Harrison, Pittsburgh, PA (US); Bo Robert Xiao, Pittsburgh, PA (US); Scott E. Hudson, Pittsburgh, PA (US)

(21) Appl. No.: 16/306,297

(22) PCT Filed: May 31, 2017
(86) PCT No.: PCT/US17/35266

§ 371 Date: Nov. 30, 2018

Related U.S. Application Data
(60) Provisional application No. 62/392,443, filed on Jun. 1, 2016.

(51) Int. Cl. G06F 3/042; G06K 9/00; G06F 3/01; G06F 3/041

(52) U.S. Cl. CPC G06F 3/0425; G06F 3/0418; G06F 3/017; G06K 9/00382

(57) ABSTRACT

Touch tracking systems and methods are described, which employ depth image information and infrared image information to robustly and accurately detect finger touches on surfaces within the touch tracking system's field of view, with accuracy exceeding the noise level of the depth image sensor. The disclosed embodiments require no prior calibration to the surface, and are capable of adapting to changes in the sensing environment. Various described embodiments facilitate providing reliable, low-cost touch tracking system for surfaces without requiring modification or instrumentation of the surface itself.

### CROSS-REFERENCE TO RELATED APPLICATIONS

This application claims priority to U.S. Provisional Patent Application Ser. No. 62/392,443, filed on Jun. 1, 2016, and entitled HYBRID DEPTH AND INFRARED IMAGE SENSING SYSTEM AND METHOD FOR ENHANCED TOUCH TRACKING ON ORDINARY SURFACES, the entirety of which is hereby incorporated by reference.

### TECHNICAL FIELD

The subject disclosure is directed to machine vision and human computer interfaces, and more particularly to touch tracking of human user touches of arbitrary and ordinary surfaces.

### BACKGROUND

Conventionally, touch interfaces have become ubiquitous for small screen devices due to the popularity of touchscreen-based smartphones and tablets. However, for much larger displays, touchscreens remain expensive and can be intrusive to install in some environments. On the other hand, walls, tables, and other relatively flat surfaces are already present in many spaces, and with the introduction of digital projectors and low-cost depth camera technologies, opportunities exist of transforming these everyday surfaces into large, touch sensitive displays.

Free-space hand and finger tracking has been studied extensively. However, comparatively little research has examined finger tracking on ordinary, arbitrary, or ad hoc surfaces. Research reveals that it is a non-trivial challenge to reliably identify a finger apart from such backgrounds and to extract its spatial position and sensing when a finger that has physically contacted a surface (e.g., versus merely hovering in close proximity to the surfaces).

Conventional depth cameras can offer a promising approach for sensing finger contacts. As a non-limiting example, research has demonstrated the feasibility of this approach for detecting touches on arbitrary surfaces, but conventional implementations are not without drawbacks. As a further non-limiting example, while conventional systems demonstrate promise for depth-based touch tracking systems, practical implementations remain elusive, as the high degree of accuracy and robust touch tracking required for practical implementations are hindered by limited capabilities of conventional depth camera systems. For instance, conventional depth camera sensors, with limited depth resolution and complicating noise characteristics, typically result in sensed fingers merging into the surface of interest at longer ranges, making precise touch detection extremely difficult.

The above-described deficiencies of conventional touch tracking techniques are merely intended to provide an overview of some of the problems of conventional systems and methods, and are not intended to be exhaustive. Other problems with conventional systems and corresponding benefits of the various non-limiting embodiments described herein may become further apparent upon review of the various non-limiting embodiments of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In various non-limiting embodiments, the disclosed subject matter provides novel touch tracking systems and methods. In non-limiting aspects, the disclosed subject matter can facilitate merging information from depth sensor imagery and infrared sensor imagery produced by one or more commodity sensor(s) to robustly and accurately detect finger touches on ordinary, arbitrary, or ad hoc surfaces within the field of view of the one or more commodity sensor(s), with accuracy exceeding the noise level of the depth image sensor, as described herein.

Accordingly, non-limiting embodiments of the disclosed subject matter can receive, by a system including a processor, depth image information and infrared image information associated with a surface and arm positions, hand positions, or finger positions associated with a user and relative to the surface, wherein the infrared image information is registered with the depth image information. Exemplary embodiments can comprise computing an edge map based on the infrared image information and computing a depth map based on the depth image information, in non-limiting aspects. In further non-limiting implementations, exemplary methods can comprise determining one or more finger position of the finger positions relative to the surface, based on the depth map as constrained at least in part by the edge map and anthropometric data related to the arm positions, the hand positions, or the finger positions relative to the surface, and determining that a touch of the surface has occurred by comparing a distance above the surface of the at least one finger position against a touch threshold. In addition, further example implementations are directed to exemplary systems comprising a finger identification component configured to determine a finger position of a number of finger positions relative to a surface, based on a depth map, as constrained in part by the edge map and anthropometric data related to the arm positions, the hand positions, or the finger positions relative to the surface, and a touch tracking component configured to determine that a touch of the surface has occurred by comparing a distance above the surface of the finger position against a touch threshold, as further detailed herein. In further non-limiting implementations, exemplary systems can comprise, a depth map component configured to compute the depth map based on depth image information associated with the surface and arm positions, hand positions, or finger positions associated with a user and relative to the surface, and an edge map component configured to compute an edge map based on infrared image information associated with the arm positions, the hand positions, or the finger positions, wherein the infrared image information is registered with the depth image information, for example, as further described herein.

These and other features of the disclosed subject matter are described in more detail below.

### BRIEF DESCRIPTION OF THE DRAWINGS

The devices, components, systems, and methods of the disclosed subject matter are further described with reference to the accompanying drawings in which:

FIG. 1 depicts a functional block diagram illustrating example non-limiting devices or systems suitable for use with aspects of the disclosed subject matter;

FIG. 2 demonstrates a comparison of depth-camera-based touch tracking methods;

FIG. 3 demonstrates another comparison of depth-camera-based touch tracking methods;

FIG. 4 illustrates an example non-limiting flow diagram of exemplary methods for performing aspects of embodiments of the disclosed subject matter;

FIG. 5 depicts portions of an exemplary algorithm that facilitates touch tracking, according to various aspects described herein;

FIG. 6 depicts results for an exemplary touch tracking process for five fingers laid flat on the table, according to non-limiting aspects described herein;

FIG. 7 depicts results of an exemplary edge detection process for five fingers laid flat on the table, according to further non-limiting aspects described herein;

FIG. 8 depicts further portions of an exemplary algorithm that facilitates touch tracking, according to various non-limiting aspects;

FIG. 9 depicts still further portions of an exemplary algorithm that facilitates touch tracking, as further described herein;

FIG. 10 depicts further portions of an exemplary algorithm that facilitates touch tracking, according to further non-limiting aspects;

FIG. 11 depicts still further portions of an exemplary algorithm that facilitates touch tracking, as further described herein;

FIG. 12 depicts further results for an exemplary touch tracking process for five fingers laid flat on the table, according to non-limiting aspects described herein;

FIG. 13 depicts results for an exemplary touch tracking process for a finger angled at 60° vertically, according to non-limiting aspects described herein;

FIG. 14 depicts further results for an exemplary touch tracking process for five fingers laid flat on the table, according to further non-limiting aspects;

FIG. 15 depicts further non-limiting portions of an exemplary algorithm that facilitates touch tracking, as further described herein;

FIG. 16 depicts a functional block diagram illustrating example non-limiting devices or systems suitable for use with aspects of the disclosed subject matter;

FIG. 17 depicts an example non-limiting device or system suitable for performing various aspects of the disclosed subject matter;

FIG. 18 illustrates an example non-limiting device or system suitable for performing various aspects of the disclosed subject matter;

FIG. 19 depicts further non-limiting aspects of an exemplary implementation as described herein;

FIG. 20 demonstrates exemplary touch tracking tasks employed to facilitate comparison of depth-camera-based touch tracking methods as described herein;

FIG. 21 demonstrates further exemplary touch tracking tasks employed to facilitate comparison of depth-camera-based touch tracking methods as described herein;

FIG. 22 demonstrates average touch positional error for five described touch tracking methods, where the error bars depict standard error;

FIG. 23 demonstrates exemplary touch detection rate for five described touch tracking methods;

FIG. 24 demonstrates average positional error after removing the average offset vector and assuming a priori knowledge of the user's orientation, where error bars depicts standard error;

FIG. 25 demonstrates 95% confidence ellipses for the crosshair task from the back of the table, where X and Y axis units are in millimeters;

FIG. 26 demonstrates 95% confidence ellipses for the crosshair task from the front of the table, where X and Y axis units are in millimeters;

FIG. 27 is a block diagram representing example non-limiting networked environments in which various embodiments described herein can be implemented; and

FIG. 28 is a block diagram representing an example non-limiting computing system or operating environment in which one or more aspects of various embodiments described herein can be implemented.

### DETAILED DESCRIPTION

Overview

As described above, a high degree of accuracy and robust touch tracking required for practical touch tracking implementations are hindered by limited capabilities of conventional depth camera systems employed in conventional touch tracking techniques. As non-limiting examples, various conventional touch tracking technologies are described as an aid to understanding the disclosed novel touch tracking systems and methods and not limitation.

As used herein, the term, “surface,” is used to refer to any physical medium in which a finger can interact and for which user interaction is to be tracked, typically by determining and tracking a “touch” of the surface. However, it can be understood that the term, “surface,” can be associated with a plurality objects having multiple surfaces, and, being defined by physical model (e.g., by a mean distance away from a sensor, characterized by a standard deviation, etc.), can be associated with an actual, physical surface or collection of physical surfaces associated with the plurality objects, that are characterized by the “surface,” in the disclosed embodiments. By way of non-limiting example, a wall can be characterized as a “surface,” a table can be characterized as a “surface,” and the combination of the wall and the table can be characterized as a surface, without limitation, whether or not the object is rigid or flexible, and whether or not the one or more objects have contiguous surfaces. In addition, as used herein, the terms, “edge map” and “edge map information,” are used interchangeably to refer to information or data, regardless of data structure, concerning an “edge,” wherein an “edge” can be understood to be associated with a physical demarcation between one or more objects' physical boundaries or a physical discontinuity between different objects in a scene. Thus, while the term “edge map” can be conventionally understood to refer to a product of an edge filter algorithm on a two-dimensional (2D) image (e.g., typically resulting in a 2D image of detected edges), which may also identify edges based on color differences, shading, etc., it can be understood that the descriptions herein are provided as an aid to understanding the disclosed embodiments and not limitation of the herein appended claims. As a result, it can be understood that the terms, “edge map” and “edge map information,” and so on, can refer to a 2D image of detected edges and/or other data structures that can be used to store or communication data or information associated with one or more “edges,” which can refer to physical demarcations between one or more objects' physical boundaries.

For instance, some conventional touch tracking techniques instrument the surface itself, either by using a surface designed for touch sensing (e.g., infrared touch surface, capacitive touch surface, etc.). In other conventional touch tracking techniques, ordinary surfaces can be instrumented with sensors, such as acoustic sensors to detect the sound of a tap or infrared emitters and receivers to detect the occlusion of a finger (e.g. infrared touchscreens, etc.). In still other conventional touch tracking techniques that operate on ad hoc uninstrumented surfaces, such techniques typically employ a sensing approach external to the surface itself. Some conventional examples include optical (e.g., camera) sensors, Light Detection and Ranging (LIDAR), and so on.

However, as described above, detecting whether a finger has contacted the surface is challenging with ordinary red/green/blue (RGB) or infrared cameras. Some conventional examples can include touch tracking based on analyzing shadows cast by a finger near the surface, touch tracking based on tracking the visual change in the fingernail when it is pressed against a surface, touch tracking employing a stereo pair of cameras, detecting touches when the finger images overlap on a surface plane, etc. Other conventional examples can employ finger dwell time or an external sensor (e.g., an accelerometer, a microphone or acoustic sensor, etc.) to detect touch events.

Still further conventional examples, employing depth camera-based touch tracking systems, which can be employed to sense physical distance from the sensor to each point in the field of view, illustrate that a high degree of accuracy and robust touch tracking required for practical touch tracking implementations are hindered by limited capabilities of conventional depth camera systems employed in conventional touch tracking techniques. As a non-limiting example, in conventional background modeling methods, conventional touch tracking techniques typically compute and store a model or snapshot of the depth background, and touches are detected where the live depth data differs from the background depth map in specific ways. A typical conventional example employs a background snapshot computed from the maximum depth point observed at each pixel over a window of time, whereas, still another employs a background model developed by analyzing the 3D structure of the scene from multiple angles, effectively providing a statistically derived background map. In still other conventional background modeling methods, non-limiting examples can employ a statistical model of the background, which can employ computing the mean and standard deviation (e.g., average noise) at each pixel.

As a further non-limiting example, in conventional finger modeling methods, conventional touch tracking techniques typically detect shapes of fingers (e.g., by using template matching, etc.), such as by employing a slice finding approach to locate characteristic cylindrical shapes of fingers in depth images, reconstructing the finger from a series of cylindrical slices, and inferring touches at the tip of the finger. Another typical conventional example models the background as a mesh and foreground objects as particles (rather than specifically as touches).

However, conventional touch tracking techniques typically do not fuse depth sensing with other sensing modalities for touch tracking. In a non-limiting example employing sensor fusion depth-sensing systems, a conventional touch tracking technique employs a multisensory approach for touch tracking, combining depth sensing with thermal imaging infrared camera that detects residual body heat on the surface, for which practical implementations are hindered by significant amount of latency (e.g., on the order of 200 milliseconds (ms)), which can provide a frustrating user experience.

Thus, to the foregoing and related ends, systems, devices, and methods are disclosed that can facilitate novel touch tracking systems and methods according to various aspects of the disclosed subject matter, among other related functions. In non-limiting aspects, the disclosed subject matter can facilitate merging information from depth sensor imagery and infrared sensor imagery produced by one or more commodity sensor(s) to robustly and accurately detect finger touches on ordinary, arbitrary, or ad hoc surfaces within the field of view of the one or more commodity sensor(s), with accuracy exceeding the noise level of the depth image sensor, as described herein. Accordingly, the subject disclosure provides non-limiting embodiments of a system, which includes the implementation of the novel method, referred to herein as DIRECT (Depth and IR Enhanced Contact Tracking). It can be understood that references to the particular non-limiting embodiment of DIRECT, as referred to herein, are provided as an aid to understanding an exemplary practical implementation of the non-limiting touch tracking algorithm that can facilitate merging depth sensor image information and infrared sensor image information, which, in some embodiments can be facilitated by a single sensor), and that can facilitate providing significantly enhanced finger tracking. As a result, various non-limiting implementations of the claims appended hereto, according to the various aspects described herein, are not limited to such non-limiting embodiments referred to herein as a DIRECT implementation.

In further non-limiting aspects, exemplary embodiments can employ infrared sensor imagery to facilitate providing precise finger boundaries and edges and can further employ depth sensor imagery to facilitate providing precise finger touch detection. In yet another non-limiting aspect, employing infrared sensor information facilitates robustly rejecting tracking errors arising from noisy depth image information. Accordingly, in particular non-limiting embodiment, DIRECT, various non-limiting embodiments can facilitate the creation of a precise 2.3 meter (m) (diagonal) touchscreen on an ordinary unmodified surface (e.g., a wood table, etc.), using only commercially available commodity hardware (e.g., Microsoft® Kinect™ 2 sensor, projector, commodity personal computer (PC), etc). As further provided herein, various non-limiting embodiments are demonstrated to outperform these conventional touch tracking techniques with respect to viable distance, touch accuracy, touch stability, false positives and false negatives, and so on.

While a brief overview has been described above in order to provide a basic understanding of some aspects of the specification, various non-limiting devices, systems, and methods are now described as a further aid in understanding the advantages and benefits of various embodiments of the disclosed subject matter. To that end, it can be understood that such descriptions are provided merely for illustration and not limitation.

### DETAILED DESCRIPTION

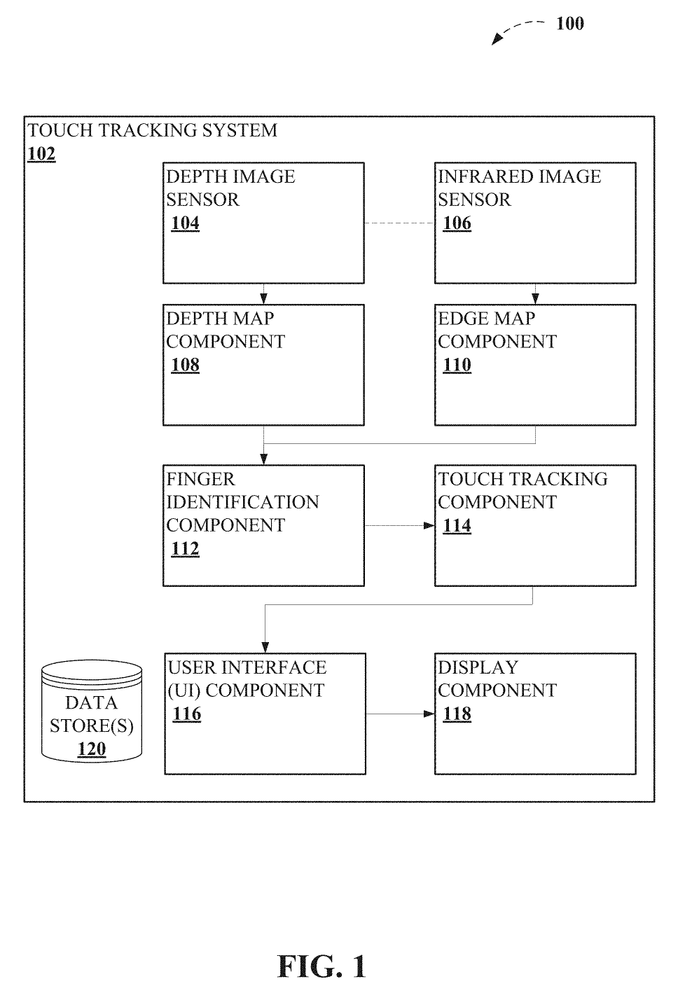

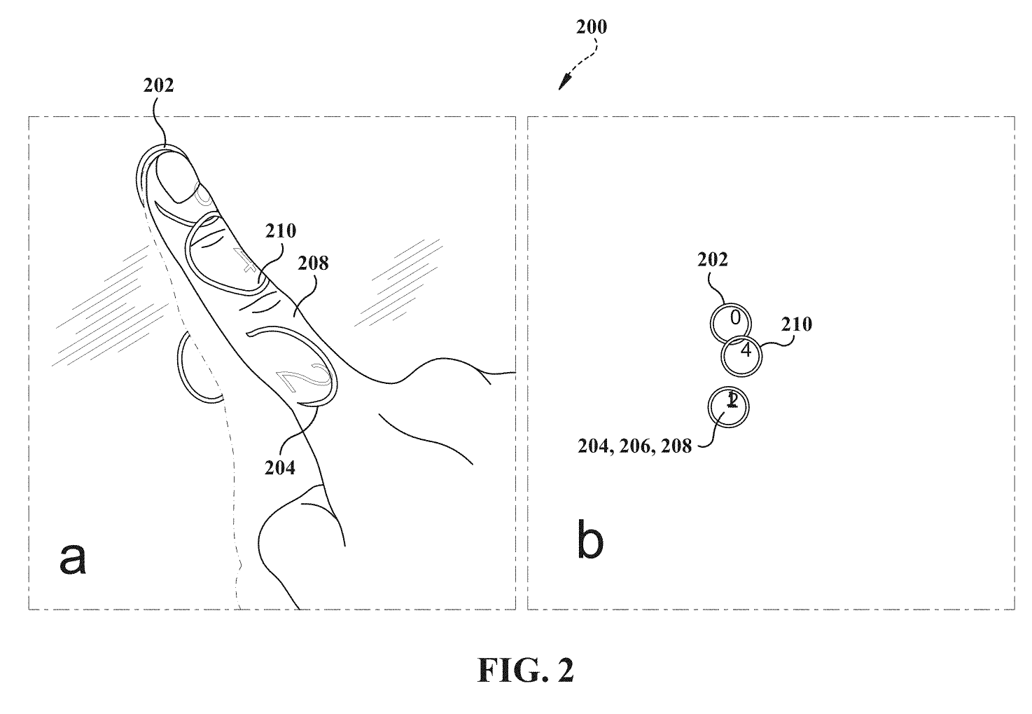

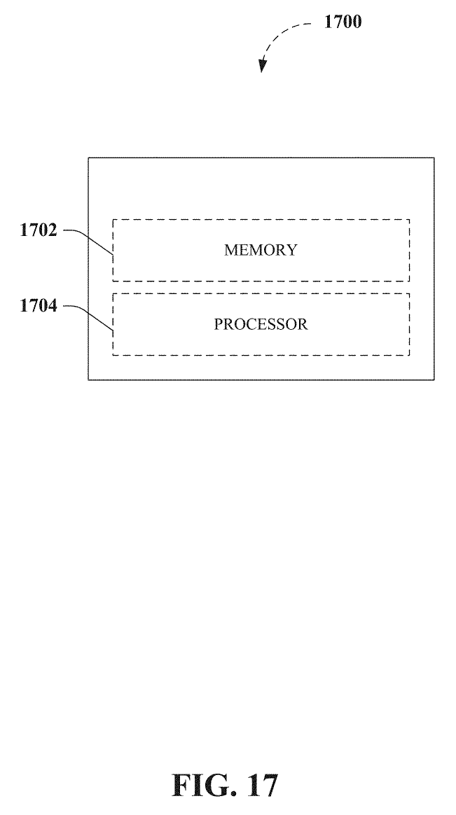

Accordingly, FIG. 1 depicts a functional block diagram 100 illustrating example non-limiting touch tracking devices or systems 102 suitable for use with aspects of the disclosed subject matter. In various non-limiting aspects, exemplary touch tracking devices or systems 102 can comprise one or more of exemplary depth image sensor 104, exemplary infrared image sensor 106, exemplary depth map component 108, exemplary edge map component 110, exemplary finger identification component 112, exemplary touch tracking component 114, exemplary user interface (UI) component 116, exemplary display component 118, one or more exemplary data store(s) 120, and/or functionality, portions, combinations, or sub combinations thereof, as further described herein, for example, regarding FIGS. 2-19. In various non-limiting embodiments, exemplary touch tracking devices or systems 102 can further comprise one or more of one or more processors (not shown) and/or one or more computer memory (not shown), for example, as further described herein, regarding FIGS. 17-18, 27-28, etc., that can facilitate performing various techniques, functions, algorithms, etc. described herein.

In non-limiting examples, exemplary touch tracking devices or systems 102 comprising exemplary depth image sensor 104 can be configured to provide depth image information. In a further non-limiting aspect, exemplary depth image information can comprise image information associated with a surface (e.g., an ordinary, arbitrary, or ad hoc surface, etc.) and one or more of arm positions, hand positions, or finger positions associated with a user, wherein the image information comprises depth information of the aforementioned relative to the surface. In other non-limiting implementations, exemplary touch tracking devices or systems 102 can be configured to transmit and/or receive depth image information to or from other systems, devices, and so on, to facilitate performing various techniques, functions, algorithms, etc. described herein.

In further non-limiting examples, exemplary touch tracking devices or systems 102 comprising exemplary infrared image sensor 106 can be configured to provide infrared image information. In further non-limiting aspect, exemplary infrared image information can comprise image information associated with a surface (e.g., an ordinary, arbitrary, or ad hoc surface, etc.) and/or one or more of arm positions, hand positions, or finger positions associated with the user, wherein the image information comprises infrared information of the aforementioned relative to the surface. In still further non-limiting aspects, exemplary touch tracking devices or systems 102 can employ infrared image information that is registered with the depth image information, as depicted in FIG. 1 (e.g., dashed line between depth image sensor 104 and infrared image sensor 106), for example, as further described herein. In other non-limiting implementations, exemplary touch tracking devices or systems 102 can be configured to transmit and/or receive infrared image information to or from other systems, devices, and so on, to facilitate performing various techniques, functions, algorithms, etc. described herein.

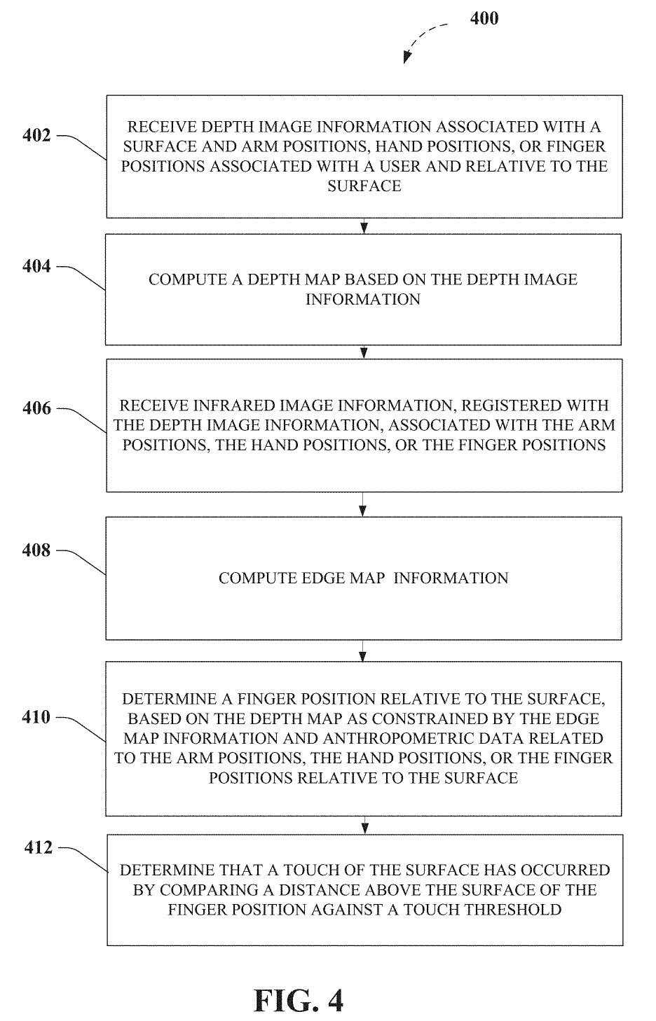

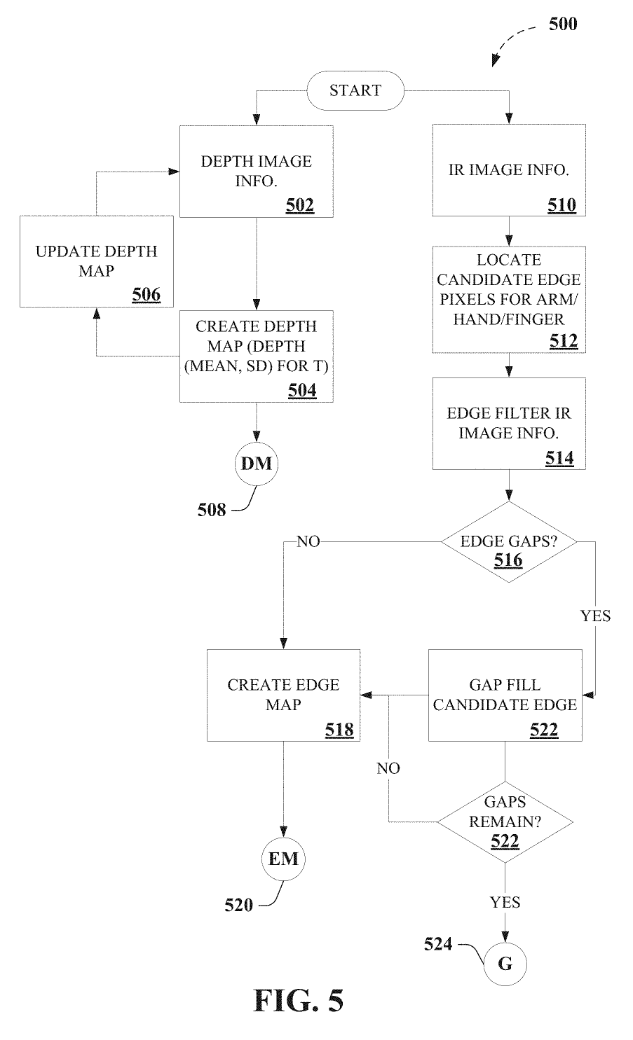

In further non-limiting examples, exemplary touch tracking devices or systems 102 comprising exemplary depth map component 108 can be configured to compute a depth map based on depth image information associated with the surface and one or more of arm positions, hand positions, or finger positions associated with a user and relative to the surface, for example, as further described herein, regarding FIGS. 4-5, etc. In other non-limiting examples, exemplary touch tracking devices or systems 102 comprising exemplary edge map component 110 can be configured to compute edge map information (e.g., based on infrared image information, based on the depth image information, etc.) associated with one or more of the arm positions, the hand positions, or the finger positions, for example, as further described herein, regarding FIGS. 4-5, etc.

In still further non-limiting examples, exemplary touch tracking devices or systems 102 comprising exemplary finger identification component 112 can be configured to determine one or more finger position of the finger positions relative to the surface, based on the depth map as constrained in part by the edge map information (e.g., based on infrared image information, based on the depth image information, etc.) and anthropometric data related to one or more of the arm positions, the hand positions, or the finger positions relative to the surface, for example, as further described herein, regarding FIGS. 4, 8-11, etc. In addition, exemplary touch tracking devices or systems 102 comprising exemplary touch tracking component 114 can be configured to determine that a touch of the surface has occurred by comparing a distance above the surface of the one or more finger position against a touch threshold, for example, as further described herein, regarding FIGS. 4, 9-15, etc.

Other non-limiting examples of exemplary touch tracking devices or systems 102 comprising exemplary UI component 116 can be configured to generate user interface information for display onto the surface that corresponds to the touch of the surface, as further described herein. As a non-limiting example, exemplary touch tracking devices or systems 102 comprising exemplary display component 118 can be configured to display user interface information onto the surface that corresponds to the touch of the surface, as described herein. In other non-limiting implementations, exemplary touch tracking devices or systems 102 can be configured to transmit and/or receive user interface information to or from other systems, devices, and so on, to facilitate performing various techniques, functions, algorithms, etc. described herein.

In further non-limiting examples, exemplary touch tracking devices or systems 102 comprising exemplary infrared image sensor 106 can comprise one or more exemplary data store(s) 120, for example, such as described herein, regarding FIGS. 17-18, 27-28, etc. In non-limiting aspects, various sources of information, data, computer-executable instructions, parameters, thresholds, and so on are described, which can be transmitted to, received from, stored in, and/or operated upon, to facilitate the various non-limiting embodiments described herein, without limitation.

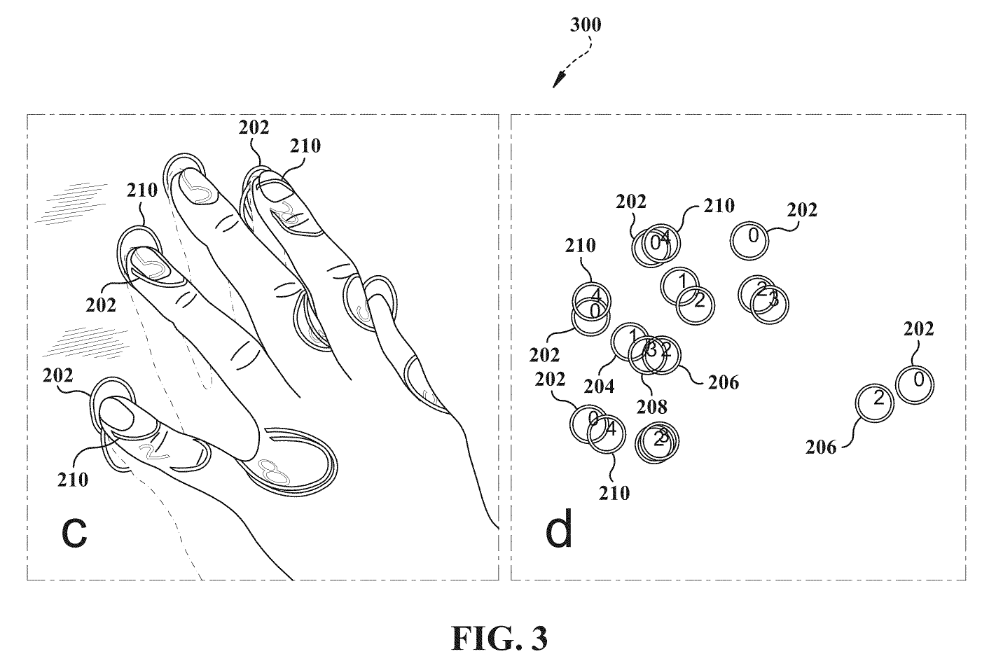

FIGS. 2-3 demonstrates comparison of different touch tracking methods for a single finger of a user, wherein the particular non-limiting implementation of DIRECT is labeled “0” (202), wherein the single frame background model is labeled “1” (204), wherein the maximum distance background model is labeled “2” (206) (overlapping “1” (204) in FIG. 2), wherein the statistical background model is labeled “3” (208) (overlapping “1” (204) or lightly displayed in FIG. 2), wherein slice finding and merging is labeled “4” (210), wherein panel “a” depicts user interface information displayed on the surface, and wherein panel “b” depicts touch position based on a determination that a touch of the service has occurred according to the various tracking methods. FIG. 2 demonstrates a comparison of depth-camera-based touch tracking methods for a single finger, whereas FIG. 3 demonstrates another comparison of depth-camera-based touch tracking methods for multiple finger touches of an entire hand.

Referring again to FIG. 1, an exemplary touch tracking devices or systems 102 (e.g., the particular non-limiting implementation of DIRECT), as well as other comparative methods demonstrated in FIGS. 2-3, were implemented in C++ on a 2.66 gigahertz (GHz), 3-core, Windows® PC, with a Kinect™ for Windows® 2 (Kinect™ 2) providing the depth image information and infrared image information (e.g., exemplary depth image sensor 104 and exemplary infrared image sensor 106, registered), in non-limiting aspects. The Kinect™ 2 is a time-of-flight depth camera, which uses active infrared illumination to determine the distances to objects in the scene, in further non-limiting aspects. The Kinect™ 2 provides 512×424 pixel depth and infrared images at 30 frames per second (fps), and a BenQ™ W1070 projector (e.g., exemplary display component 120) with a resolution of 1920×1080 was also mounted above the test surface (an ordinary wooden table) to provide user interface information for visual feedback, according to further non-limiting aspects.

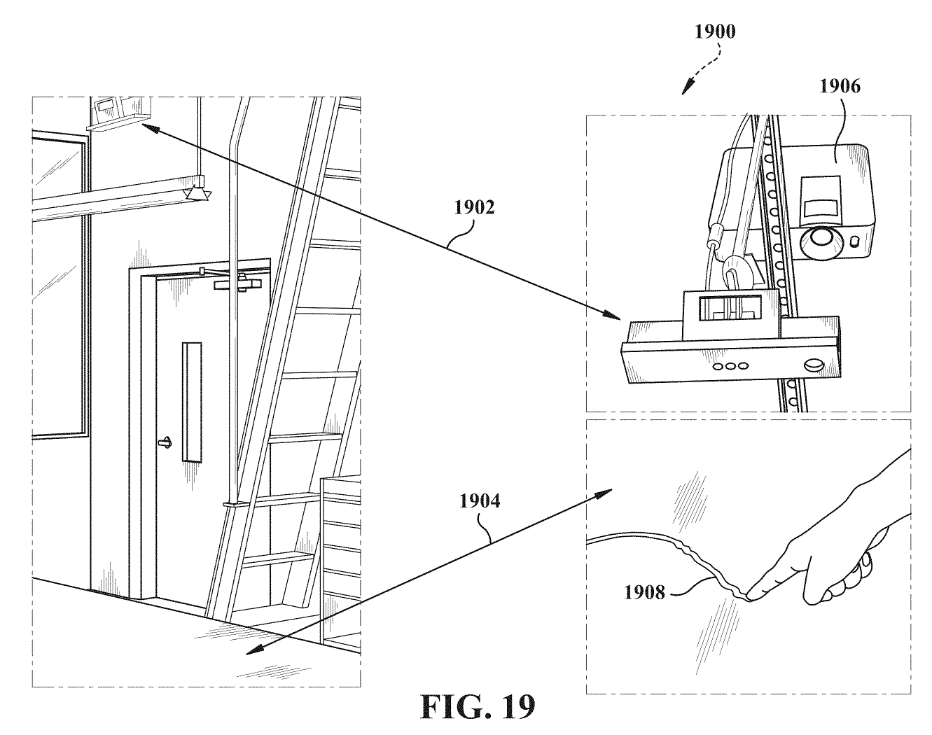

As depicted in FIG. 19, for example, a Kinect™ 2 was mounted 1.60 m above a large table surface (e.g., the ordinary, arbitrary, or ad hoc surface etc.), and the projector was located 2.35 m above the surface, in further non-limiting aspects. Accordingly, for the particular non-limiting implementation of DIRECT, in the horizontal edges of the Kinect™ 2's field of view, the table surface is 2.0 m from the Kinect™ 2. In further non-limiting aspects, the projector and Kinect™ 2 were securely mounted to the ceiling and were calibrated to each other using multiple views of a planar calibration target. In further non-limiting aspects, an exemplary non-limiting implementation provides a configuration that allows the projector to project a 1.0 m×2.0 m image onto the table surface, with the Kinect™ 2 capable of sensing objects across the entire projected area, where, at this distance, each projected pixel is 1.0 square millimeters (mm²), and each Kinect™ 2 depth pixel is 4.4 mm² at the table surface. Note that, even with this second generation Kinect™ sensor, a typical fingertip resting on the table is less than 5 depth image pixels wide.

Accordingly, an exemplary touch tracking devices or systems 102 (e.g., the particular non-limiting implementation of DIRECT) can be configured to model both the background and one or more of arms, hands, and fingers associated with the user, thus, effectively combining background modeling and finger modeling to facilitate providing practical touch tracking implementations having a high degree of accuracy and robust touch tracking. In a further non-limiting aspect, an exemplary processing pipeline can be optimized so that it runs at the full 30 fps using a single core of the PC.

In view of the example embodiments described supra, methods that can be implemented in accordance with the disclosed subject matter will be better appreciated with reference to the flowcharts of FIGS. 4-5, 8-11, and 15, for example. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks may be required to implement the methods described hereinafter. Additionally, it should be further understood that the methods and/or functionality disclosed hereinafter and throughout this specification are capable of being stored on an article of manufacture to facilitate transporting and transferring such methods to computers, for example, as further described herein. The terms computer readable medium, article of manufacture, and the like, as used herein, are intended to encompass a computer program accessible from any computer-readable device or media such as a tangible computer readable storage medium.

FIG. 4 illustrates an example non-limiting flow diagram of exemplary methods 400 for performing aspects of embodiments of the disclosed subject matter. In a non-limiting example, exemplary methods 400 can comprise, at 402, receiving (e.g., by exemplary touch tracking system 102, etc.) depth image information (e.g., via exemplary depth image sensor 104, etc.) associated with a surface and arm positions, hand positions, or finger positions associated with a user and relative to the surface, for example, as further described herein, regarding FIG. 5, etc.

In a further non-limiting example, exemplary methods 400 can comprise, at 404, computing (e.g., by exemplary touch tracking system 102, exemplary depth map component 108, portions thereof, etc.) a depth map based on the depth image information, for example, as further described herein, regarding FIGS. 1, 5, etc. In a non-limiting aspect, exemplary methods 400 can comprise computing (e.g., by exemplary touch tracking system 102, exemplary depth map component 108, portions thereof, etc.) a depth mean and a depth standard deviation for pixels associated with the surface based on the depth image information provided by a depth image sensor (e.g., exemplary depth image sensor 104, etc.) over a predetermined time period, wherein the depth map is determined relative to a position of the depth image sensor, for example, as further described herein, regarding FIGS. 1, 5, etc. In addition, exemplary methods 400 can comprise updating (e.g., by exemplary touch tracking system 102, exemplary depth map component 108, portions thereof, etc.) the depth mean and the depth standard deviation for the pixels while the depth standard deviation remains less than a predetermined depth-dependent threshold, according to further non-limiting aspects, as described herein, regarding FIGS. 1, 5, etc.

In another non-limiting example, exemplary methods 400 can comprise, at 406, receiving (e.g., by exemplary touch tracking system 102, exemplary infrared image sensor 106, portions thereof, etc.) infrared image information (e.g., via exemplary infrared image sensor 106, etc.) associated with the arm positions, the hand positions, or the finger positions, wherein the infrared image information is registered with the depth image information, for example, as further described herein, regarding FIGS. 1, 5, etc. In addition, further non-limiting implementations of exemplary methods 400 can comprise receiving (e.g., by exemplary touch tracking system 102, exemplary depth image sensor 104, portions thereof, etc.) the depth image information comprising time of flight depth image information and receiving (e.g., by exemplary touch tracking system 102, exemplary infrared image sensor 106, portions thereof, etc.) the infrared image information comprising reflected infrared light information as a result of unstructured infrared illumination on the surface as provided by a single sensor.

In a further non-limiting example, exemplary methods 400 can comprise, at 408, computing (e.g., by exemplary touch tracking system 102, exemplary edge map component 110, portions thereof, etc.) edge map information (e.g., based on the infrared image information, based on the depth image information, etc.), for example, as further described herein, regarding FIG. 5, etc. Further non-limiting implementations of exemplary methods 400 can comprise locating (e.g., by exemplary touch tracking system 102, exemplary edge map component 110, portions thereof, etc.) candidate edge pixels associated with the arm positions, the hand positions, or the finger positions, based on the infrared image information provided by an infrared image sensor (e.g., exemplary infrared image sensor 106, etc.), for example, as further described herein, regarding FIG. 5, etc. In addition, further non-limiting implementations of exemplary methods 400 can comprise performing (e.g., by exemplary touch tracking system 102, exemplary edge map component 110, portions thereof, etc.) an edge detection filter on the infrared image information and performing a gap-filling procedure on the edge map information or determining that a gap exists in the edge map information, according to further non-limiting aspects, for example, as described herein, regarding FIG. 5, etc. In still further non-limiting implementations, exemplary methods 400 can comprise computing the edge map information based in part on one or more of the depth image information, the infrared image information, and/or combinations or sub combinations thereof.

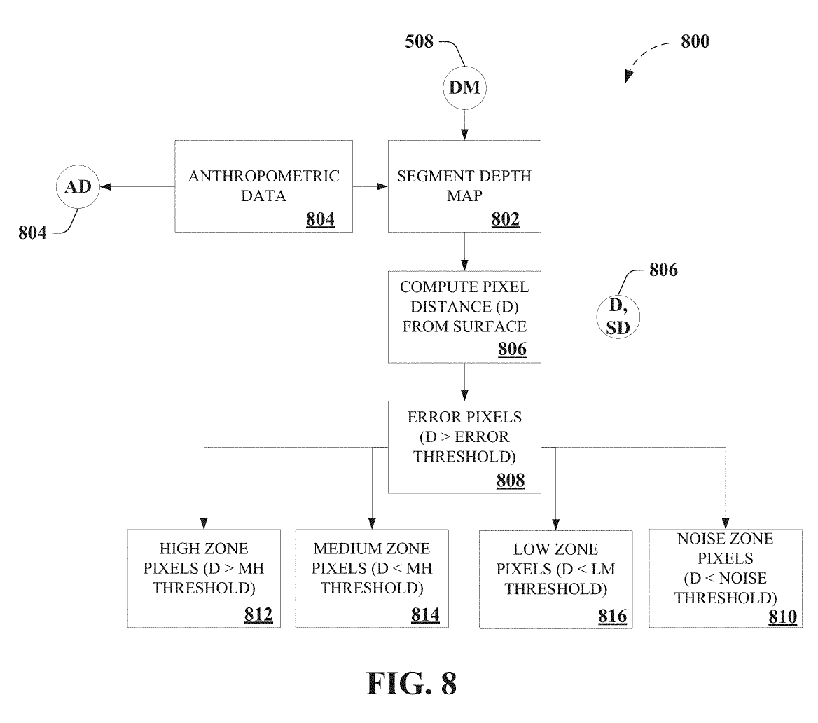

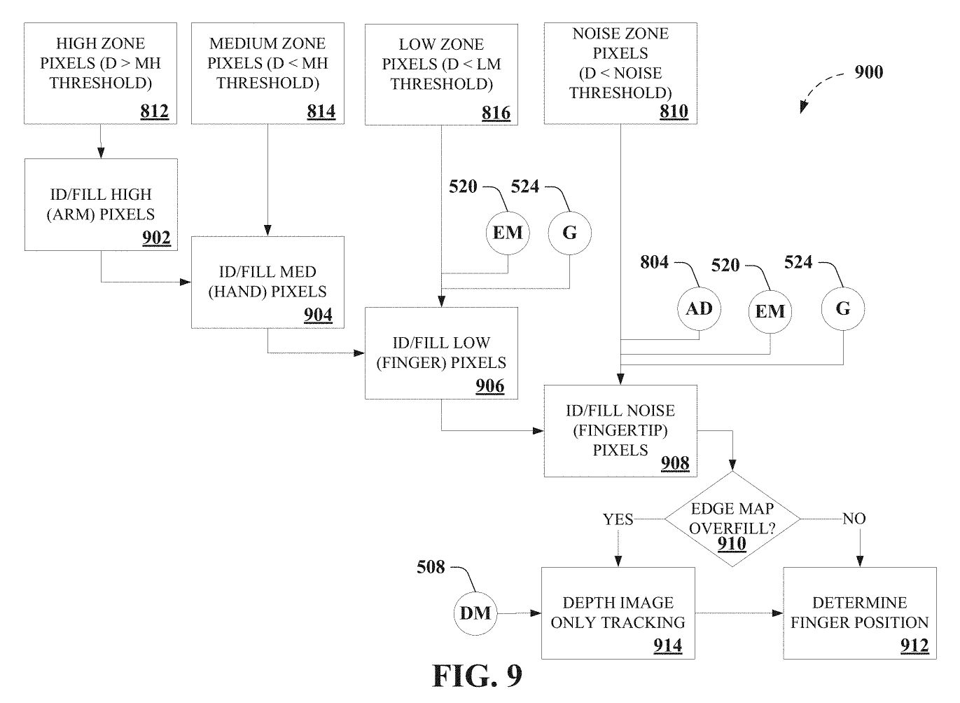

In still other non-limiting examples, exemplary methods 400 can comprise, at 410, determining (e.g., by exemplary touch tracking system 102, exemplary finger identification component 112, portions thereof, etc.) one or more finger position of the finger positions relative to the surface, based on the depth map as constrained at least in part by the edge map information and anthropometric data related to one or more of the arm positions, the hand positions, or the finger positions relative to the surface, for example, as further described herein, regarding FIGS. 9-15, etc. In a non-limiting aspect, exemplary methods 400 can comprise segmenting (e.g., by exemplary touch tracking system 102, exemplary finger identification component 112, portions thereof, etc.) the depth map into one or more of depth zones, wherein the one or more depth zones can be characterized by distance from the surface, for example, as further described herein, regarding FIG. 8, etc. In another non-limiting aspect, exemplary methods 400 can comprise determining and discarding (e.g., by exemplary touch tracking system 102, exemplary finger identification component 112, portions thereof, etc.) error pixels in the depth map characterized by the distance from the surface exceeding an error threshold. In further non-limiting examples, exemplary methods 400 can comprise determining (e.g., by exemplary touch tracking system 102, exemplary finger identification component 112, portions thereof, etc.) noise pixels in the depth map characterized by the distance from the surface being less than a noise threshold, less than one standard deviation (e.g., one standard deviation or one z unit in the background model), etc., as belonging to a noise zone, as further described herein. In still further non-limiting aspects, exemplary methods 400 can further comprise segmenting (e.g., by exemplary touch tracking system 102, exemplary finger identification component 112, portions thereof, etc.) the depth map into an “above-noise zone” and determining (e.g., by exemplary touch tracking system 102, exemplary finger identification component 112, portions thereof, etc.) “above-noise” pixels in the depth map characterized by the distance from the surface being greater than the noise threshold, for example, as further described herein, regarding FIGS. 8-11, etc.

Additionally, in a non-limiting aspect, exemplary methods 400 can further comprise segmenting (e.g., by exemplary touch tracking system 102, exemplary finger identification component 112, portions thereof, etc.) the depth map into one or more of a high zone, a medium zone, and a low zone, wherein boundaries between the one or more of depth zones can be derived from the anthropometric data related to the arm positions, the hand positions, or the finger positions, for example, as further described herein, regarding FIG. 8, etc. In further non-limiting examples, exemplary methods 400 can comprise sequentially determining (e.g., by exemplary touch tracking system 102, exemplary finger identification component 112, portions thereof, etc.) pixels associated with the one or more depth zones, wherein the pixels associated with the one or more depth zones correspond to one or more of the arm positions, the hand positions, or the finger positions relative to the surface. In addition, in still other non-limiting examples, sequentially determining the pixels associated with the one or more depth zones can comprise determining (e.g., by exemplary touch tracking system 102, exemplary finger identification component 112, portions thereof, etc.) pixels associated with the high zone, determining pixels associated with the medium zone, determining (e.g., by exemplary touch tracking system 102, exemplary finger identification component 112, portions thereof, etc.) pixels associated with the low zone, and determining (e.g., by exemplary touch tracking system 102, exemplary finger identification component 112, portions thereof, etc.) pixels associated with the noise zone, in order, wherein completion of a preceding step triggers a subsequent step, for example, as further described herein, regarding FIGS. 8-11, etc.

In further non-limiting examples, exemplary methods 400 can comprise sequentially determining (e.g., by exemplary touch tracking system 102, exemplary finger identification component 112, portions thereof, etc.) the pixels associated with the one or more depth zones, as described herein. For instance, sequentially determining (e.g., by exemplary touch tracking system 102, exemplary finger identification component 112, portions thereof, etc.) the pixels associated with the one or more depth zones can comprise identifying (e.g., by exemplary touch tracking system 102, exemplary finger identification component 112, portions thereof, etc.) the pixels associated with the one or more depth zones in the high zone as arm pixels, identifying (e.g., by exemplary touch tracking system 102, exemplary finger identification component 112, portions thereof, etc.) the pixels associated with the one or more depth zones in the medium zone as hand pixels, and/or identifying (e.g., by exemplary touch tracking system 102, exemplary finger identification component 112, portions thereof, etc.) the pixels associated with the one or more depth zones in the low zone as finger pixels, and identifying (e.g., by exemplary touch tracking system 102, exemplary finger identification component 112, portions thereof, etc.) the pixels associated with the one or more depth zones in the noise zone as fingertip pixels, for example, as further described herein, regarding FIGS. 8-11, etc. In non-limiting aspects, identifying the pixels associated with the one or more depth zones in the high zone as the arm pixels comprises discriminating (e.g., by exemplary touch tracking system 102, exemplary finger identification component 112, portions thereof, etc.) based on the depth map. In further non-limiting aspects, identifying the pixels associated with the one or more depth zones in the medium zone as the hand pixels comprises identifying (e.g., by exemplary touch tracking system 102, exemplary finger identification component 112, portions thereof, etc.) the pixels associated with the one or more depth zones in the medium zone in a direction from the high zone to the low zone and discriminating (e.g., by exemplary touch tracking system 102, exemplary finger identification component 112, portions thereof, etc.) against surrounding pixels having high depth variance, for example, as further described herein, regarding FIG. 9, etc. In still further non-limiting aspects, identifying the pixels associated with the one or more depth zones in the low zone as the finger pixels comprises discriminating (e.g., by exemplary touch tracking system 102, exemplary finger identification component 112, portions thereof, etc.) based on the edge map information and comprises discriminating (e.g., by exemplary touch tracking system 102, exemplary finger identification component 112, portions thereof, etc.) against the pixels associated with the one or more depth zones in the noise zone based on an identified discontinuity in the edge map information, for example, as further described herein, regarding FIG. 9, etc. In yet other non-limiting aspects, identifying the pixels associated with the one or more depth zones in the noise zone as the fingertip pixels comprises identifying (e.g., by exemplary touch tracking system 102, exemplary finger identification component 112, portions thereof, etc.) pixels that do not extend beyond an edge of the edge map information and do not extend beyond a threshold distance from nearest ones of the hand pixels based on the anthropometric data, for example, as further described herein, regarding FIG. 9, etc.

In further non-limiting examples, exemplary methods 400 can comprise, determining (e.g., by exemplary touch tracking system 102, exemplary finger identification component 112, portions thereof, etc.) the one or more finger position based on the depth map as a result of one or more of the identified discontinuity in the edge map, identifying (e.g., by exemplary touch tracking system 102, exemplary finger identification component 112, portions thereof, etc.) pixels that do extend beyond the edge of the edge map information, or identifying (e.g., by exemplary touch tracking system 102, exemplary finger identification component 112, portions thereof, etc.) pixels that do extend beyond the threshold distance from the hand pixels based on the anthropometric data, for example, as further described herein, regarding FIGS. 8-11, etc. For instance, exemplary methods 400 comprising determining the one or more finger position of the finger positions can further comprise adding (e.g., by exemplary touch tracking system 102, exemplary finger identification component 112, portions thereof, etc.) the finger tip pixels to connected ones of the finger pixels, determining (e.g., by exemplary touch tracking system 102, exemplary finger identification component 112, portions thereof, etc.) a maximum distance from the nearest ones of the hand pixels to connected ones of the finger tip pixels, determining (e.g., by exemplary touch tracking system 102, exemplary finger identification component 112, portions thereof, etc.) a finger-tip pixel of the finger tip pixels having the maximum distance, and/or assigning (e.g., by exemplary touch tracking system 102, exemplary finger identification component 112, portions thereof, etc.) a position of the finger-tip pixel as the one or more finger position of the finger positions, for example, as further described herein, regarding FIGS. 8-11, etc.

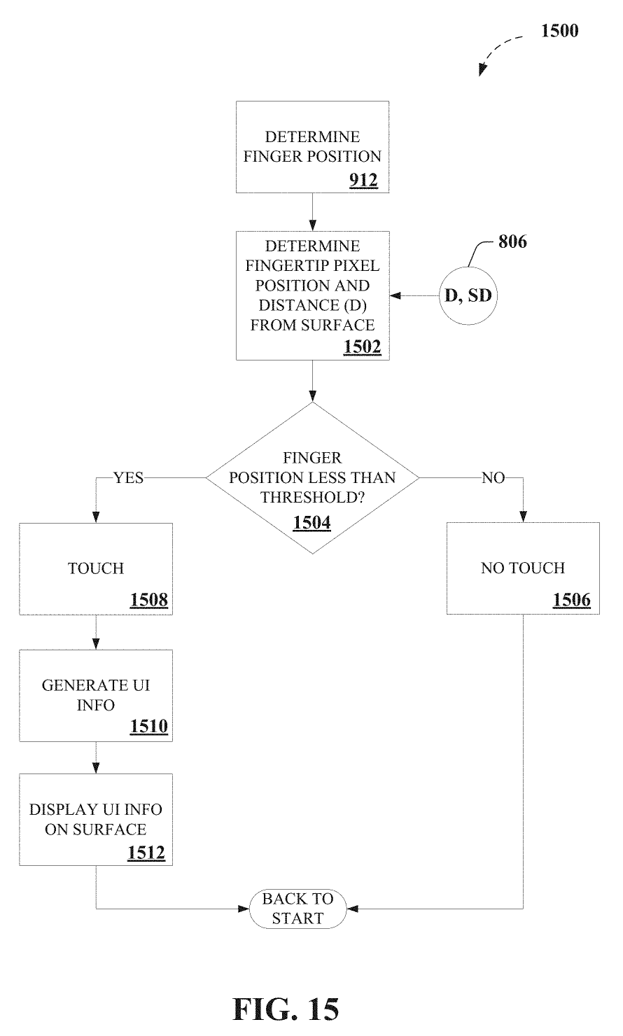

In other non-limiting examples, exemplary methods 400 can comprise, at 412, determining (e.g., by exemplary touch tracking system 102, exemplary touch tracking component 114, portions thereof, etc.) that a touch of the surface has occurred by comparing a distance above the surface of the one or more finger position against a touch threshold, for example, as further described herein, regarding FIGS. 9-15, etc. In further non-limiting examples, exemplary methods 400 can comprise determining (e.g., by exemplary touch tracking system 102, exemplary touch tracking component 114, portions thereof, etc.) that the touch of the surface has occurred, which can further comprise averaging (e.g., by exemplary touch tracking system 102, exemplary touch tracking component 114, portions thereof, etc.) the distance above the surface of a subset of the finger tip pixels nearest the finger-tip pixel of the finger tip pixels having the maximum distance, and/or determining (e.g., by exemplary touch tracking system 102, exemplary touch tracking component 114, portions thereof, etc.) the touch threshold based in part on a width of a finger associated with the user derived from at least a subset of the finger pixels, for example, as further described herein, regarding FIG. 15, etc.

In other non-limiting implementations, exemplary methods 400 can comprise generating (e.g., by exemplary touch tracking system 102, exemplary UI component 116, portions thereof, etc.) user interface information for display (e.g., via exemplary display component 118) onto the surface that corresponds to the touch of the surface.

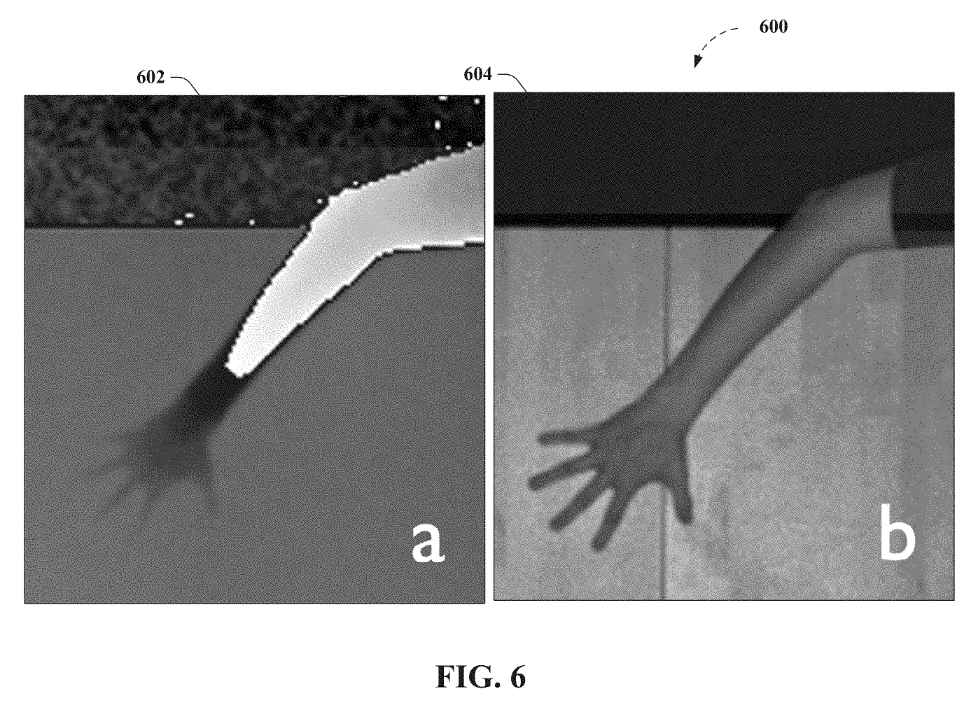

FIG. 5 depicts portions 500 of an exemplary algorithm that facilitates touch tracking, according to various aspects described herein. For instance, non-limiting implementations, as described herein, can employ background modeling and infrared edge detection, in non-limiting aspects. For example, exemplary implementations can employ a statistical model of the background based on depth image information 502 (e.g., via exemplary depth image sensor 104, etc.), for example, as depicted in FIG. 6. In further non-limiting aspects, a predetermined window T of depth image information 502 data can be recorded (e.g., an exemplary 5 second window of depth image information 502 data, etc.) at every pixel. In still further non-limiting aspects, the mean and standard deviation (SD) of the depth data over this window T can be computed at 504. It is noted that such a background model or depth map (DM) 508 can facilitate establishing both a highly accurate mean background depth as well as a noise profile at every pixel in the scene for the surface (e.g., an ordinary, arbitrary, or ad hoc surface, etc.), which depth map 508 can be employed elsewhere in exemplary algorithms, as further described herein.

In addition, in further non-limiting aspects, exemplary embodiments can employ dynamic updating of the background model or depth map at 506, in which, for each pixel, the background mean and standard deviation can be continually computed for a running window T (e.g., an exemplary 5 second window of depth image information 502 data, etc.). In further non-limiting aspects, if the standard deviation for a pixel exceeds a predetermined depth-dependent threshold (e.g., a predetermined depth-dependent threshold accounting for higher average noise further from the sensor, etc.), the pixel background model mean and standard deviation can be held constant until the moving average drops below the predetermined depth-dependent threshold. According to non-limiting aspects, embodiments employing the predetermined depth-dependent threshold to facilitate dynamic updating of the background model or depth map can facilitate accurately tracking long-term changes in the environment (e.g., objects being moved around the surface), while ignoring short-term changes (e.g., hands and fingers actively interacting with interfaces). In another example embodiment, the background model or depth map can be updated in a separate processor thread, for example, running at a fraction of the depth image information 502 rate (e.g., 15 fps versus 30 fps of the depth image information 502, etc.), which can avoid excessive dynamic updating of the background model or depth map. It is further noted that highly stationary hands and fingers could theoretically be “integrated into the background” by employing dynamic updating of the background model or depth map. However, it is further noted that, in practice, users rarely stay stationary for several seconds over top of active touch interfaces. In further non-limiting aspects, dynamic updating of the background model or depth map can facilitate accommodating shifts in the background or surface environment, whereas conventional background modeling typically employed only a single static background model captured during initial setup.

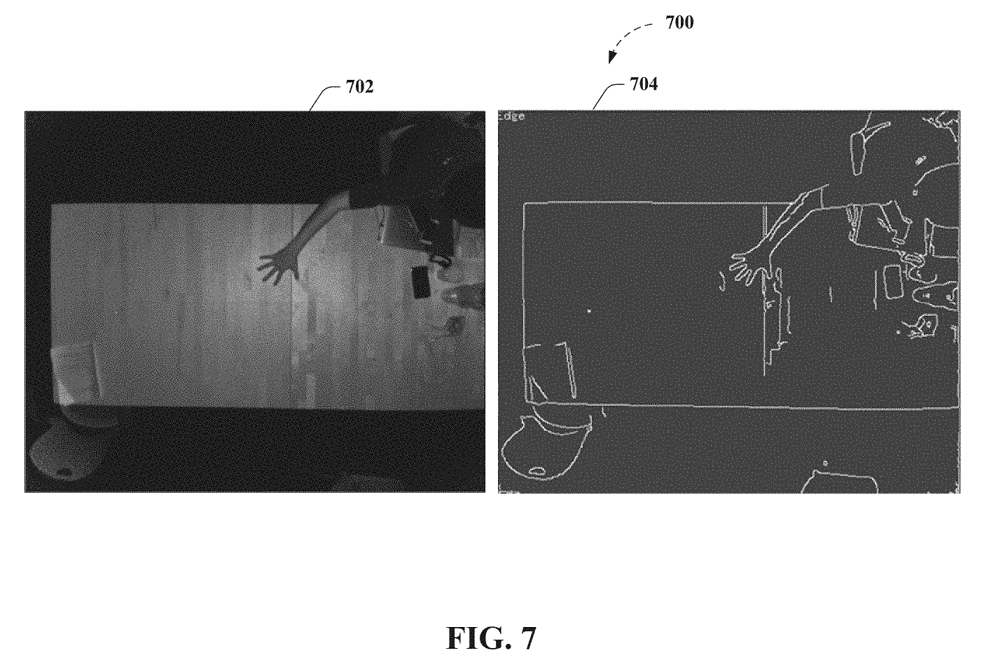

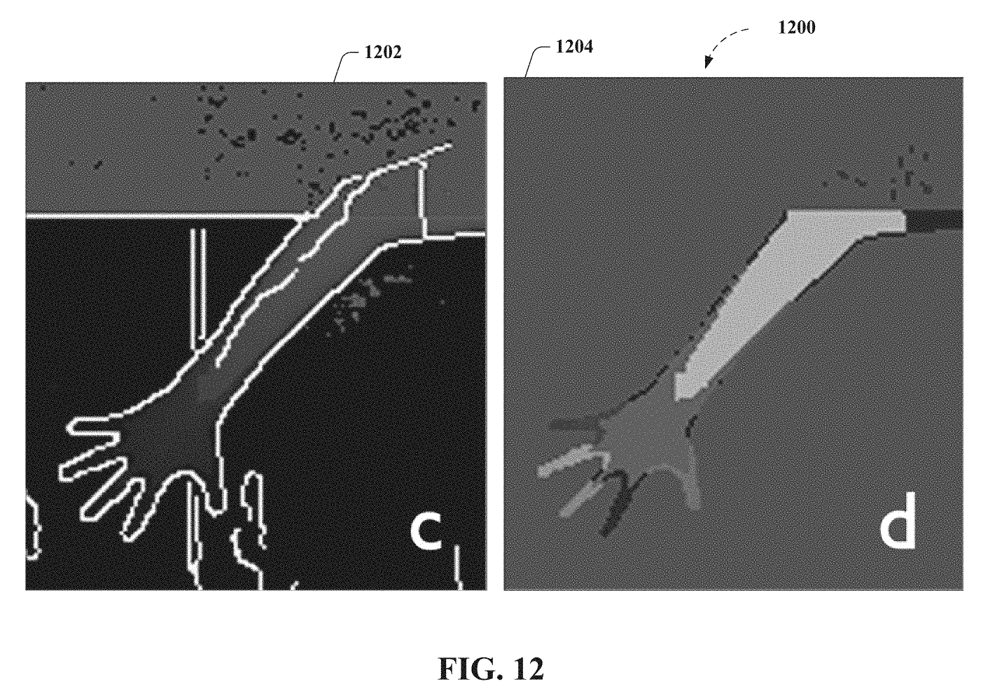

In further non-limiting examples, exemplary implementations can employ infrared edge detection, as described herein. For example, exemplary implementations can employ infrared image information 510 (e.g., via exemplary infrared image sensor 106, etc.) to facilitate detecting a boundary between the fingertip and the surrounding surface, for example, as depicted in FIGS. 6-7. Accordingly, in further non-limiting aspects, candidate edge pixels for one or more of an arm, hand, and/or finger can be located at 512, for example, such as by performing edge detection filter at 514, to facilitate detecting edges in the infrared image information 510. As further described herein, in still further non-limiting aspects, exemplary touch tracking devices or systems 102 can employ infrared image information that is registered with the depth image information, as depicted in FIG. 1. For instance, Kinect™ 2's infrared image information 510 is provided from the same sensor as the depth image information 502, which provides infrared invention information 510 that is precisely registered to depth image information 502. In further non-limiting aspects, an exemplary edge filter (e.g., a Canny edge filter, a 7×7 Sobel filter, with hysteresis thresholds of 4000 and 8000, etc.) can be employed to locate candidate edge pixels in the infrared image information 510. However, other edge filters can be employed, and/or edge filter parameters can be tuned to perform with particular implementations, for example, such as with the Kinect™ 2's infrared image, for example, as depicted in FIGS. 7 and 12. However, it is noted that the edge filter parameters are not specific to the operating depth or objects in the scene, in further non-limiting aspects.

It can be appreciated that, after locate candidate edge pixels in the infrared image information 510, employing an edge filter, some edges may have gaps or discontinuities, which can occur due to, for example, multiple edges meeting at a point, etc. Thus, in further non-limiting aspects, at 516, it can be determined whether one or more gaps or discontinuities exists for the candidate edge pixels to create the edge map at 518, which edge map 520 can be employed elsewhere in exemplary algorithms, as further described herein. In still further non-limiting aspects, exemplary embodiments can perform a gap-filling algorithm (e.g., an exemplary edge-linking algorithm, etc.) to gap fill candidate edges at 522 across the edge map. As a non-limiting example, an exemplary gap-filling algorithm can process edge boundaries (e.g., Canny edge boundaries, etc.) and can bridge one-pixel gaps or discontinuities between neighboring edges, for example, to fill a gap or discontinuities if it encounters the end of an edge while traversing it, and if the edge is within a predetermined number of pixels (e.g., 2 pixels, etc.) of another edge, in still further non-limiting aspects. It is noted that surfaces with a very similar infrared albedo to skin could cause issues for edge finding, but according to various embodiments described herein, shadows cast by the arm and hand (e.g., illuminated by an active IR emitter found associated with conventional depth cameras), even near the fingertip, can facilitate increasing contrast. It is further noted that, after applying an exemplary gap-filling algorithm, fingertips and hands are usually clearly enclosed by edge boundaries. However, whereupon encountering larger edge gaps or discontinuities, an exemplary gap-filling algorithm as described herein can store (e.g., via one or more exemplary data store(s) 120, etc.) such gaps or discontinuities 524, which can be employed elsewhere in exemplary algorithms, as further described herein.

It can be understood that, while FIG. 5 depicts edge map 520 as constructed based on infrared image information 510 as an aid to understanding the various disclosed embodiments, the techniques for touch tracking as described herein are no so limited. As a non-limiting example, edge map 520, edge map information, and so on, can be constructed based on infrared image information 510, based on depth image information 502, and so on, and/or combinations or sub combinations thereof, in further non-limiting aspects, as further described herein. By way of non-limiting example, edge map 520, edge map information, and so on, constructed based on depth image information 502 can provide sufficient information to facilitate various aspects as described herein, such as, for instance, in determining, identifying, or classifying pixels that differ in height by more than a noise threshold, one standard deviation (e.g., one standard deviation or one z unit), etc. from the background as “above-noise” pixels, as described herein regarding FIGS. 8-11, etc.

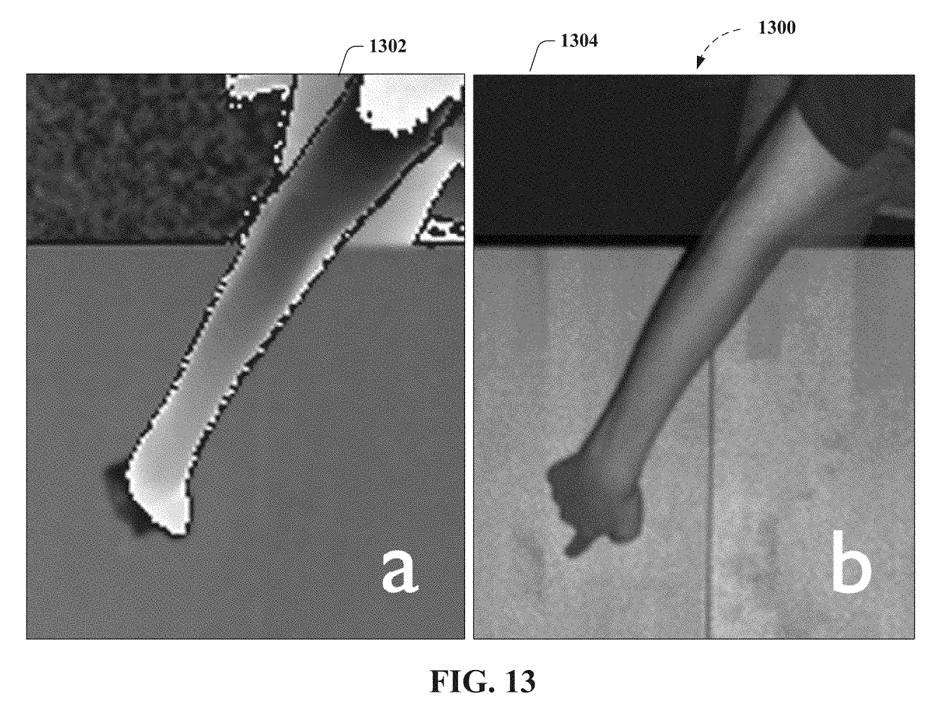

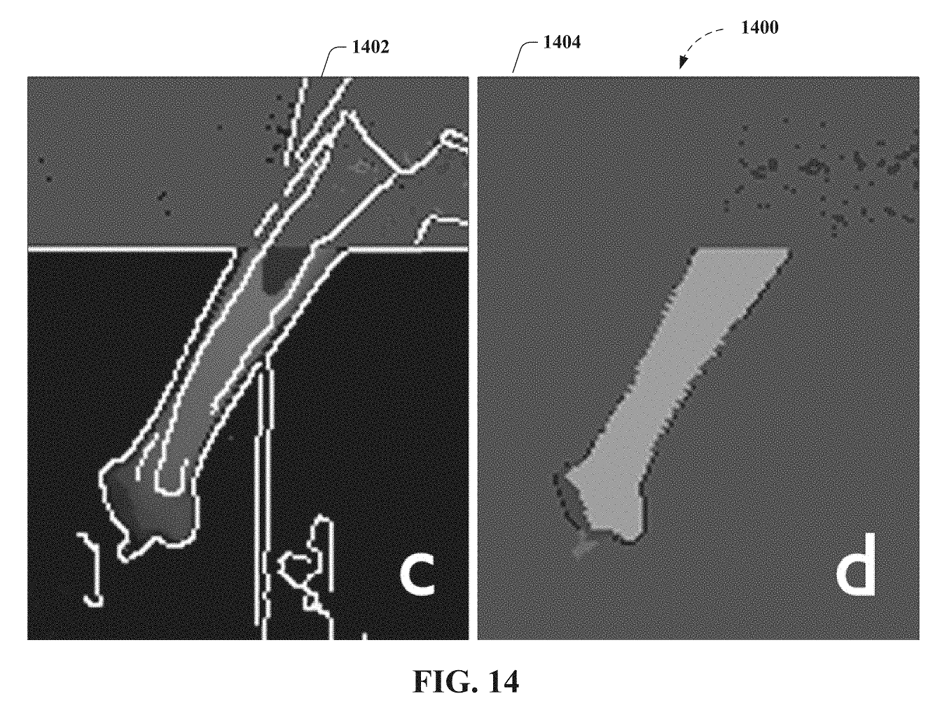

Exemplary non-limiting results of above described process can be seen for example, as depicted in FIGS. 7 and 12 (panel “c”) as the light overlay lines outlining the arm, hand, and fingers of a test subject. For instance, FIGS. 6-7 and 12 show an example tracking process for five fingers laid flat on an exemplary surface (e.g., an ordinary, arbitrary, or ad hoc surface, etc.) comprising a table, for example, as further described herein, regarding FIGS. 1 and 19. FIGS. 6-7 and 12 depict a hand laid flat on the table, which is a challenging case for physical touchscreens, but in which exemplary embodiments as described herein (e.g., DIRECT) locates touches by using overhead depth data. FIG. 6 depicts results for an exemplary touch tracking process for five fingers laid flat on the table, according to non-limiting aspects described herein, wherein panel “a” 602 depicts exemplary depth image information 502 (e.g., via exemplary depth image sensor 104, etc.), and wherein panel “b” 604 depicts exemplary infrared image information 510 (e.g., via exemplary infrared image sensor 106, etc.). FIG. 7 depicts results of an exemplary edge detection process for five fingers laid flat on the table, according to further non-limiting aspects described herein, wherein panel 702 depicts exemplary infrared image information 510 (e.g., via exemplary infrared image sensor 106, etc.), and wherein panel 704 depicts exemplary candidate edge boundaries (e.g., Canny edge boundaries, etc.). In FIGS. 6-7 and 12 (as well as in FIGS. 13-14), it is noted that the fingertips are below the noise threshold of the Kinect™ 2, about which analysis of the infrared image can be employed to accurately detect touches of the surface, as further described herein.

As can be seen in FIG. 6 (as well as in FIG. 13) exemplary depth image information 502 (e.g., via exemplary depth image sensor 104, etc.) is relatively noisy data (e.g., large SD for the mean depth in the background model or depth map of the surface). Thus, with the hand laid flat on the table, it is difficult to discriminate between the hand and the background, as the hand gets lost in the noise, which renders performance of conventional depth-camera-only touch tracking techniques unsatisfactory. To determine objects of interests that are high off the surface (e.g., greater than about 5 centimeters (cm)), various non-limiting implementations can employ depth image information 502 (e.g., via exemplary depth image sensor 104, etc.), without relying on the infrared image information 510 (e.g., via exemplary infrared image sensor 106, etc.), in non-limiting aspects. As a non-limiting example, arms are thick enough to always be above noise, and so they are easily determined by employing depth image information 502 (e.g., via exemplary depth image sensor 104, etc.), without relying on the infrared image information 510 (e.g., via exemplary infrared image sensor 106, etc.). However, for objects that are close to the surface (e.g., such as for a fingertip touching a table, which is less than about 2 centimeters (cm)), various non-limiting implementations can employ edge map information derived from infrared image information 510 (e.g., via exemplary infrared image sensor 106, etc.), or otherwise, in addition to depth image information 502 (e.g., via exemplary depth image sensor 104, etc.). Thus, while what follows is a particular non-limiting implementation provided as an aid to understanding non-limiting aspects described herein, and not limitation, it is noted that further implementations are possible without incorporation each specific detail of the exemplary implementations herein (e.g., multiple zones, arm zones, etc.). Accordingly, non-limiting implementations, as described herein, can employ depth map segmentation of depth image information 502 (e.g., via exemplary depth image sensor 104, etc.) into two or more zones, to facilitate touch tracking as described herein, in non-limiting aspects, such that various non-limiting embodiments can infer which pixels should be identified or classified by employing depth image information 502 (e.g., via exemplary depth image sensor 104, etc.), without relying on the infrared image information 510 (e.g., via exemplary infrared image sensor 106, etc.), and can infer which pixels should be identified or classified by employing edge map information derived from infrared image information 510 (e.g., via exemplary infrared image sensor 106, etc.), or otherwise, in addition to depth image information 502 (e.g., via exemplary depth image sensor 104, etc.).

FIG. 8 depicts further portions 800 of an exemplary algorithm that facilitates touch tracking, according to various non-limiting aspects. For instance, non-limiting implementations, as described herein, can employ depth map segmentation at 802 of depth image information 502 (e.g., via exemplary depth image sensor 104, etc.) into two or more zones, to facilitate touch tracking as described herein, in non-limiting aspects. In a particular non-limiting example, depth image information 502 (e.g., via exemplary depth image sensor 104, etc.) can be segmented into five distinct zones based on background model or depth map 508. In further non-limiting aspects, anthropometric data 804 can be employed to facilitate determining the various zones employed to facilitate touch tracking as described herein, as well as in other aspects as described herein. For instance, anthropometric data 804 that can be employed to facilitate determining the various zones, thresholds, and so on employed to facilitate touch tracking as described herein.

Accordingly, pixel distance from the background in absolute units (mm), and in terms of the pixel's background standard deviation (z-units) at 806, in further non-limiting aspects. At 808, pixels can be identified or classified as “error pixels,” for example, for pixels that are further than an error threshold (e.g., 1 cm, etc.) from the background, as the background should represent the maximum depth of the background model or depth map 508, in a non-limiting aspect. It is noted that such error pixels can arise due to multipath interference with the depth sensor and due to objects moving around on the surface. In a further non-limiting aspect, error pixels can be disregarded in the various embodiments described herein. In still another non-limiting aspect, pixels that differ in height by less than a noise threshold, one standard deviation (e.g., one standard deviation or one z unit), etc. from the background can be identified or classified at 810 as “noise” pixels, as they lie below the noise threshold of the background model or depth map 508. It is noted that, the domain of such noise pixels is, by anthropometric considerations based on the anthropometric data 804, domain of interest to facilitate touch tracking, as described herein.

In further non-limiting aspects, because remaining pixels are significantly different from the background, such pixels, by anthropometric considerations based on the anthropometric data 804, can be considered potential arm or hand pixels. Accordingly, in a further non-limiting embodiment, such pixels can be further divided into zones (e.g., a “high” zone at 812, a “low” zone at 814, and a “medium” zone at 816), based on pixel distance from the background and a threshold based on based on the anthropometric data 804. As particular non-limiting examples, a low-medium (LM) threshold can be set at 12 mm, and a medium-high (MH) threshold can be set at 50 mm). Accordingly, as can be seen FIG. 8, four zones of interest can be employed, and non-limiting aspects, which can be seen as depicted as gradients of pixels in FIG. 12, 1202, and FIG. 14, 1402, comprising high pixels, medium pixels, low pixels, and noise pixels. This segmentation of pixels can be employed to facilitate determining one or more finger positions relative to the surface based on further identification or classification of such pixels as being associated with one or more of and arm, a hand, a finger, and/or a finger tip.

FIG. 9 depicts still further portions 900 of an exemplary algorithm that facilitates touch tracking, as further described herein. For instance, non-limiting implementations, as described herein, can employ a progressive flood-filling algorithm, whereby further identification or classification of such pixels as being associated with one or more of and arm, a hand, a finger, and/or a finger tip is accomplished, according to non-limiting aspects. Thus, to facilitate touch tracking, exemplary embodiments can employ a sequence of flood fill operations (e.g., four flood fills in the particular non-limiting implementation of DIRECT) into each of the zones (e.g., each of the four zones), which are referred to as “arm” filling at 902, “hand” filling at 904, “finger” filling at 906, and finger “tip” filling at 908, when filling high pixels, medium pixels, low pixels, and noise pixels respectively, in further non-limiting aspects. In addition, as a flood fill for a zone completes, it can trigger the next fill in the sequence starting from pixels on its boundary, wherein a flooded area can be linked to a “parent” area from which it was seeded (e.g., a filled finger is seeded by a filled hand that it is attached to), and wherein a flood fill operates according to a set of rules (e.g., different rules for each zones), thereby forming a hierarchy of filled objects, according to still further non-limiting aspects.

As described above, anthropometric data 804 can be employed to facilitate determining the various zones, thresholds, and so on employed to facilitate touch tracking as described herein. In a particular non-limiting example, arm pixels can be defined as pixels that are at least 5 cm closer to image sensors than the background mean (e.g., pixels that are at least 5 cm above the surface), which high threshold can facilitate unambiguously distinguishing human activity from background noise, where standard deviations (noise) at the edge of the depth map 508 can reach approximately 1.5 cm (e.g., 5 cm is more than 3 standard deviations away) and to facilitate detection of human forearms even when laid totally flat on the surface (e.g., where 6.3 cm is the 2.5th percentile diameter of a human forearm). In further non-limiting examples, hand pixels can be defined as pixels that are at least 12 mm from the surface, which threshold can facilitate segmenting individual fingers apart from the hand (e.g., where 12 mm is the 2.5th percentile thickness of a human finger) and facilitating detection of even small fingers laying flat on a table. In still further non-limiting examples, finger tip pixels of interest, which are by definition, below the background noise, can be constrained if the finger tip pixels extend more than 15 cm from the finger base (e.g., allowing both the longest human fingers having mean length 8.6 cm, SD 0.5, and is 2 standard deviations above the mean palm center to fingertip length (mean 12.9 cm, SD 0.8)).

In addition, exemplary flood fill rules can be defined on the classification of pixels, capture properties of the depth image information 502 (e.g., via exemplary depth image sensor 104, etc.) and infrared image information 510 (e.g., via exemplary infrared image sensor 106, etc.), etc. For instance, at 902, high pixels, which can be employed to identify parts of arms as they are substantially far away from the background, an exemplary flood fill algorithm can be employed to extract blobs of high confidence pixels, flooding down to the MH threshold, which can employ depth image information 502 (e.g., via exemplary depth image sensor 104, etc.), without relying on the infrared image information 510 (e.g., via exemplary infrared image sensor 106, etc.), as the high pixels are readily segmented.

In addition, at 904, continuing with pixels bounding the high area, an exemplary flood fill algorithm can be employed to fill downwards towards the LM threshold and the low pixels to identify “hands” pixels fill, wherein the exemplary flood fill algorithm can be constrained to avoid pixels with high depth variance in their local neighborhood, to ensure that this flood fill does not simply fill into noisy pixels surrounding the arm. At 906, an exemplary flood fill algorithm can be employed to fill into the low pixels, wherein the exemplary flood fill algorithm can be constrained to stay within the edge map 520 (e.g., infrared edge map, etc.) information derived from infrared image information 510 (e.g., via exemplary infrared image sensor 106, etc.). In a further non-limiting aspect, in the event of identified gaps or discontinuities 524, the exemplary flood fill algorithm can be stopped at noise pixels (e.g., pixel distance less than one standard deviation (e.g., one z unit) from the background) to constrain the flood fill within the bounds reliable data. In yet another non-limiting aspect, resulting filled low pixels can be considered a candidate finger.

At 908, an exemplary flood fill algorithm can be employed to fill into the noise pixels (e.g., pixel distance less than one standard deviation (e.g., one z unit) from the background), and a further non-limiting aspect, wherein the fill is constrained to stay within the edge map 520 (e.g., infrared edge map, etc.) information derived from infrared image information 510 (e.g., via exemplary infrared image sensor 106, etc.). It can be understood that, because depth values no longer constrain this fill, any hole in the infrared image information 510 (e.g., via exemplary infrared image sensor 106, etc.) or edge map 520 can cause the flood fill algorithm to flood uncontrollably onto the surface. Thus, in a further non-limiting aspect, in the event of identified gaps or discontinuities 524, the exemplary flood fill algorithm can be stopped, based anthropometric considerations based on the anthropometric data 804. As a non-limiting example, if the furthest pixel visited by the exemplary flood fill algorithm is more than a maximum expected distance from the seed point (e.g., 15 cm, a distance much longer than most human fingers, etc.), then the exemplary flood fill algorithm can be inferred to have approached an overfill condition. If an overfill condition is detected at 910, the exemplary flood fill algorithm can reset all flooded pixels and return a failure indication, in a further non-limiting aspect, which can facilitate exemplary touch tracking embodiments system to gracefully fall back to touch tracking based on employing depth image information 502 (e.g., via exemplary depth image sensor 104, etc.) only at 914, without relying on the infrared image information 510 (e.g., via exemplary infrared image sensor 106, etc.), in the event that the infrared image information 510 (e.g., via exemplary infrared image sensor 106, etc.) is unusable for any reason (e.g. because there are holes in the edge image), which can facilitate touch tracking by exemplary embodiments, albeit with reduced performance, in cluttered or complex environments, such as when the edge map 520 is damaged or unusable. Accordingly, if an overfill condition is not detected at 910, the exemplary flood fill algorithm can add the finger “tip” pixels to the parent “finger's” pixels, to facilitate determining finger position at 912, as further described herein, for example, which can be seen as depicted as gradients of pixels in FIG. 12, 1204, and FIG. 14, 1404.

As described above, non-limiting implementations can employ depth map segmentation of depth image information 502 (e.g., via exemplary depth image sensor 104, etc.) into two or more zones, to facilitate touch tracking as described herein, in non-limiting aspects, such that various non-limiting embodiments can infer which pixels should be identified or classified by employing depth image information 502 (e.g., via exemplary depth image sensor 104, etc.), without relying on the infrared image information 510 (e.g., via exemplary infrared image sensor 106, etc.), and can infer which pixels should be identified or classified by employing edge map information derived from infrared image information 510 (e.g., via exemplary infrared image sensor 106, etc.), or otherwise, in addition to depth image information 502 (e.g., via exemplary depth image sensor 104, etc.).

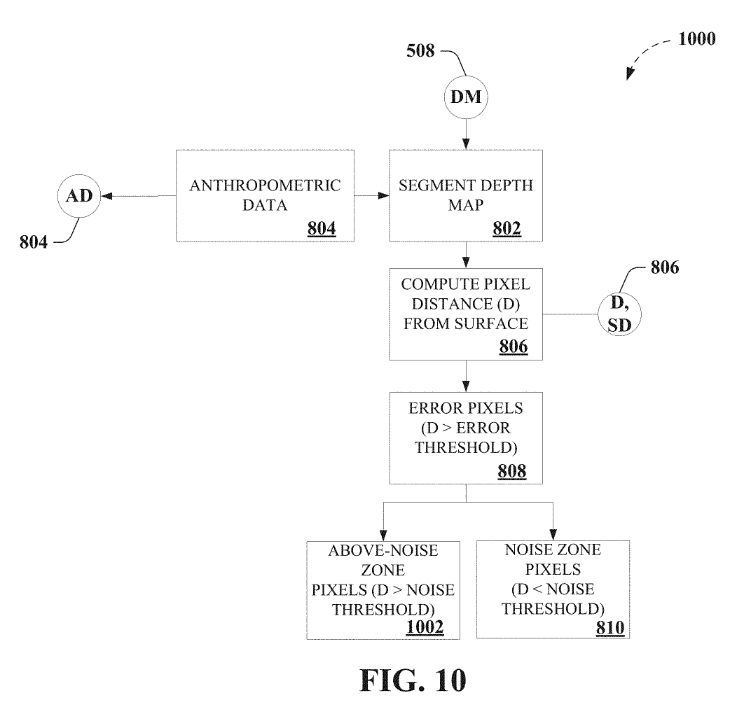

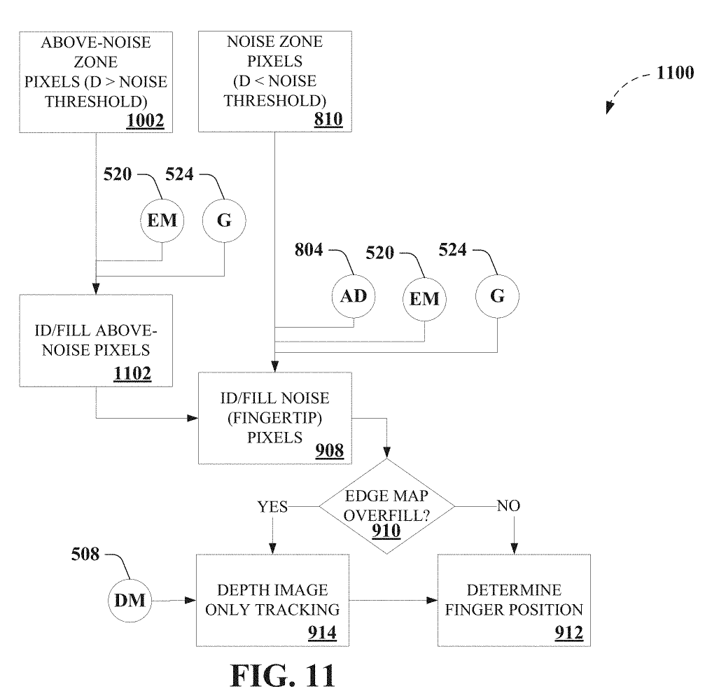

Accordingly, FIGS. 10-11 depict further portions 1000 and 1100 of an exemplary algorithm that facilitates touch tracking, according to further non-limiting aspects. As can be seen in FIGS. 10-11, portions 1000 and 1100 of an exemplary algorithm that facilitates touch tracking can proceed as described above, regarding FIGS. 8-9, for example, and comprising segmentation of depth image information 502 (e.g., via exemplary depth image sensor 104, etc.) into two zones comprising “above-noise” pixels (e.g., pixels significantly above the noise) at 1002, which can be identified or classified by employing depth image information 502 (e.g., via exemplary depth image sensor 104, etc.), without relying on the infrared image information 510 (e.g., via exemplary infrared image sensor 106, etc.), for example, and comprising “noise” pixels (e.g., pixels that have the potential to be lost in the noise) at 810, which pixels need to be identified or classified by employing edge map information derived from infrared image information 510 (e.g., via exemplary infrared image sensor 106, etc.), or otherwise, in addition to depth image information 502 (e.g., via exemplary depth image sensor 104, etc.).

For example, as further described herein, a statistical model of the background (e.g., computing the mean and standard deviation, or average noise, at each pixel), for example, such as for depth map 508 can facilitate establishing both a highly accurate mean background depth as well as a noise profile at every pixel in the scene for the surface, in further non-limiting aspects. As such, pixels that differ in height by less than a noise threshold, one standard deviation (e.g., one standard deviation or one z unit), etc. from the background can be identified or classified at 810 as “noise” pixels, as they lie below the noise threshold of the background model or depth map 508, whereas pixels that differ in height by more than a noise threshold, one standard deviation (e.g., one standard deviation or one z unit in the background model), etc., from the background can be identified or classified at 1002 as “above-noise” pixels, as they lie above the noise threshold of the background model or depth map 508, in further non-limiting aspects. In addition, as further described above regarding FIG. 9, for example, further non-limiting implementations can employ a progressive flood-filling algorithm, whereby further identification or classification of such pixels as being associated with one or more of and arm, a hand, a finger, and/or a finger tip is accomplished, according to non-limiting aspects. Thus, exemplary embodiments can employ a sequence of flood fill operations (e.g., two flood fills in the particular non-limiting implementation of FIGS. 10-11) into each of the zones (e.g., each of the “above-noise” zone and the “noise” zones), which are referred to as “above-noise” filling at 1102 and “noise” or finger “tip” filling at 908, as further described above regarding FIG. 9, in further non-limiting aspects.

FIG. 12 depicts further results for an exemplary touch tracking process for five fingers laid flat on the table, wherein panel “c” 1202 depicts exemplary depth image information 502 (e.g., via exemplary depth image sensor 104, etc.)(e.g., z-score) overlaid with edge map 520 (e.g., infrared edge map, etc.) information derived from infrared image information 510 (e.g., via exemplary infrared image sensor 106, etc.), showing high pixels, medium pixels, low pixels, noise pixels, and error pixels, and wherein panel “d” 1204 depicts segmentation and filling result of filled and merged blobs (e.g., arm blob, hand blob, finger blobs (merged with tips), according to non-limiting aspects described herein.

FIGS. 13-14 show a single finger raised 60°, which is a difficult case for depth-based touch trackers, as there are very few depth values available for identification or classification of the fingertip itself. For example, FIG. 13 depicts results for an exemplary touch tracking process for a finger angled at 60° vertically, according to non-limiting aspects described herein, wherein panel “a” 1302 depicts exemplary depth image information 502 (e.g., via exemplary depth image sensor 104, etc.), and wherein panel “b” 1304 depicts exemplary infrared image information 510 (e.g., via exemplary infrared image sensor 106, etc.). FIG. 14 depicts further results for an exemplary touch tracking process for five fingers laid flat on the table, wherein panel “c” 1402 depicts exemplary depth image information 502 (e.g., via exemplary depth image sensor 104, etc.)(e.g., z-score) overlaid with edge map 520 (e.g., infrared edge map, etc.) information derived from infrared image information 510 (e.g., via exemplary infrared image sensor 106, etc.), showing high pixels, medium pixels, low pixels, noise pixels, and error pixels, and wherein panel “d” 1404 depicts segmentation and filling result of filled and merged blobs (e.g., arm blob, hand blob, finger blobs (merged with tips), according to non-limiting aspects described herein.

FIG. 15 depicts further non-limiting portions 1500 of an exemplary algorithm that facilitates touch tracking, as further described herein. For instance, non-limiting implementations, as described herein, can employ an exemplary fingertip extraction algorithm to facilitate determining that a touch of the surface has occurred, for example, by comparing a distance above the surface of the finger position against a touch threshold. For example, having accurately determined the position of one or more finger tip at 912, exemplary non-limiting embodiments can employ such finger identification to facilitate determining that a touch of the surface has occurred. As a non-limiting example, during both the finger fill at 906 and finger tip fill at 908, distance to the nearest connected medium-or-higher pixel (hand pixel) can be recorded, and for each detected finger, a fingertip can be inferred to be placed at the pixel with the highest such distance, in further non-limiting aspects. As further described herein, this pixel is shown to correlate well with the fingertip's actual location, and can provide an inferred fingertip, which is stable such that that touch position smoothing is unnecessary. It can be understood that other algorithms are possible, as well as touch position smoothing, as desired, depending on design of the touch tracking system. Additionally, and/or alternatively, if the fingertip filling failed due to an overflow at 910, the fingertip's position can be estimated using forward projection, by using the hand's position to determine the direction of the finger, in further non-limiting aspects, with the resulting estimate expected to be substantially noisier, which can be accommodated by employing a higher-level filtering or smoothing algorithm.

In further non-limiting implementations, after determining fingertip pixel position and distance from the surface at 1502, whether a touch of the surface has occurred can be determined by averaging the depth differences (e.g. distance above the surface) corresponding to a predetermined number of finger/tip pixels (e.g., 8 finger/tip pixels in a particular non-limiting implementation) with the highest distance (e.g., highest distance to the nearest connected medium-or-higher pixel (hand pixel)), and compare the result against a predetermined touch threshold at 1504. In a further numbering aspect, hysteresis can be employed to avoid rapid flips in touch state. In a further non-limiting aspect, predetermined touch threshold used herein could be configured to take into account, anthropometric data 804, physical size of a detected finger, etc., since a finger's thickness can correlate to its width, to enable extremely accurate hover/click detection across a wide range of users. In various embodiments, if no touch of the surface has been determined to have occurred at 1506, the process can repeat by returning back to FIG. 5, in a non-limiting aspect. In a further non-limiting aspect, if a touch of the surface has been determined to have occurred at 1508, further non-limiting embodiments can facilitate generating (e.g., by exemplary touch tracking system 102, exemplary UI component 116, portions thereof, etc.), at 1510, user interface information for display (e.g., by exemplary touch tracking system 102, exemplary display component 118, portions thereof, etc.) at 1512 onto the surface that corresponds to the touch of the surface, as further described herein, after which, the process can repeat by returning back to FIG. 5.

Accordingly, various non-limiting embodiments as described herein, can facilitate touch tracking for a surface (e.g., an ordinary, arbitrary, or ad hoc surface, etc.). In the particular non-limiting example described herein (e.g., DIRECT), various embodiments can merge aspects of optical tracking, background modeling, and finger modeling. As further described herein, compared to depth-only methods, the touch points detected by the particular non-limiting example described herein (e.g., DIRECT) are more stable, as the infrared estimation provides pixel-accurate detection of the finger-tip. Consequently, the particular non-limiting example described herein (e.g., DIRECT) requires no temporal touch smoothing to work well, allowing it to have very low latency (15 ms average) without sacrificing accuracy. In addition, while the particular non-limiting example described herein (e.g., DIRECT) employs aspects of finger modeling, it can be understood that various embodiments as described herein do not directly model the shape of fingers, nor do they make assumptions about the shape of the touch contact area. As a result, the particular non-limiting example described herein (e.g., DIRECT) is capable of tracking touches when fingers assume unusual configurations, such as holding all fingers together, which flexibility enables more advanced interactions (e.g., gestural touches), as well as allowing users to be more flexible with their input. However, it can be understood that the particular non-limiting example described herein (e.g., DIRECT) is provided as an aid to understanding various non-limiting aspects, and not limitation. As a result, it can be further understood that various aspects as described herein should not be construed as essential, preferable, and/or required elements of the subject claims appended hereto, nor should the particular non-limiting embodiments described herein, along with design choices specifically included or excluded in the various descriptions herein be construed comprising a beneficial effect, advantage, and/or improvement without considering the context, as merely exemplary in nature.

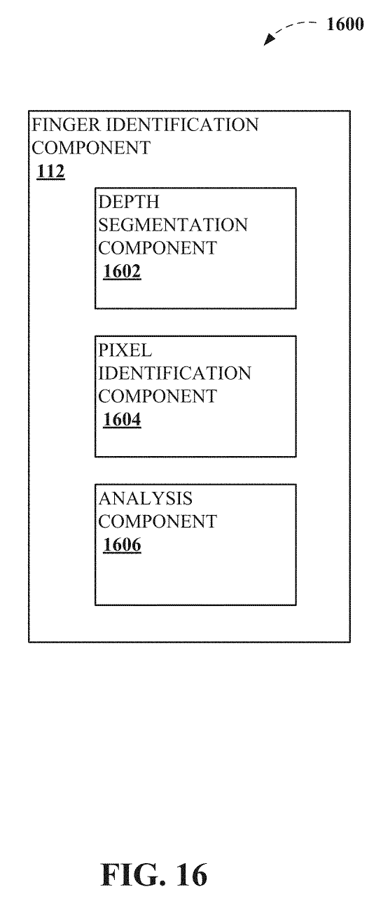

In view of the example embodiments described supra, devices and systems that can be implemented in accordance with the disclosed subject matter will be better appreciated with reference to the flowcharts of FIGS. 16-19. While for purposes of simplicity of explanation, the example devices and systems are shown and described as a collection of blocks, it is to be understood and appreciated that the claimed subject matter is not limited by the order, arrangement, and/or number of the blocks, as some blocks may occur in different orders, arrangements, and/or combined and/or distributed with other blocks or functionality associated therewith from what is depicted and described herein. Moreover, not all illustrated blocks may be required to implement the example devices and systems described hereinafter. Additionally, it should be further understood that the example devices and systems and/or functionality disclosed hereinafter and throughout this specification are capable of being stored on an article of manufacture to facilitate transporting and transferring such methods to computers, for example, as further described herein. The terms computer readable medium, article of manufacture, and the like, as used herein, are intended to encompass a computer program accessible from any computer-readable device or media such as a tangible computer readable storage medium.

### Example Systems and Devices

As a non-limiting example, FIG. 16 depicts a functional block diagram 1600 illustrating example non-limiting devices or systems suitable for use with aspects of the disclosed subject matter. For example, returning to FIG. 1, therein is described exemplary touch tracking devices or systems 102 that can comprise one or more of exemplary depth image sensor 104, exemplary infrared image sensor 106, exemplary depth map component 108, exemplary edge map component 110, exemplary finger identification component 112, exemplary touch tracking component 114, exemplary UI component 116, exemplary display component 118, one or more exemplary data store(s) 120, and/or functionality, portions, combinations, and/or sub combinations thereof, as further described herein, for example, regarding FIGS. 2-19. In a further non-limiting example, exemplary embodiments as described herein can comprise sub combinations of components, and/or portions thereof, whether integrated distributed or otherwise. Accordingly, it can be understood that depth image information 502 can be received and/or transmitted from disparate devices (e.g., via exemplary depth image sensor 104, etc.) as can infrared image information 510 (e.g., via exemplary infrared image sensor 106, etc.), with or without depth map 508, and/or edge map 520, and so on.

Nevertheless, it can be understood that various non-limiting embodiments as described herein can be realized by virtually in this combinations of components, subcomponents, combinations, sub combinations, and so on. Accordingly, FIG. 16 depicts an exemplary non-limiting implementation comprising an exemplary finger identification component 112. In non-limiting aspects, exemplary finger identification component 112 can comprise one or more of depth segmentation component 1602, pixel identification component 1604, and/or analysis component 1606, and/or functionality, portions, combinations, and/or sub combinations thereof, as further described herein, for example, regarding FIGS. 2-19. In yet another non-limiting aspect, one or more of depth segmentation component 1602, pixel identification component 1604, and/or analysis component 1606, and/or functionality, portions, combinations, and/or sub combinations thereof, can be configured to perform functions, algorithms, inferences, determinations, etc., without limitation, as described above, for example, regarding FIGS. 8-12 and 14. In further non-limiting aspects, one or more of depth segmentation component 1602, pixel identification component 1604, and/or analysis component 1606, and/or functionality, portions, combinations, and/or sub combinations thereof, as well as one or more of exemplary depth map component 108, exemplary edge map component 110, exemplary finger identification component 112, exemplary touch tracking component 114, exemplary UI component 116, exemplary display component 118, functionality, portions, combinations, or sub combinations thereof, can be embodied on a non-transitory computer readable storage medium (e.g., one or more exemplary data store(s) 120, a computer memory or storage medium, or otherwise, etc.) comprising the herein described computer executable components that, in response to execution by a computing device, cause the computing a device to execute or facilitate execution of the computer executable components, for example, as further described herein.

For example, FIG. 17 depicts a functional block diagram illustrating example non-limiting devices or systems suitable for use with aspects of the disclosed subject matter. For instance, FIG. 17 illustrates example non-limiting devices or systems 1700 suitable for performing various aspects of the disclosed subject matter in accordance with exemplary non-limiting touch tracking devices or systems 102, one or more of depth segmentation component 1602, pixel identification component 1604, and/or analysis component 1606, and/or functionality, portions, combinations, and/or sub combinations thereof, as well as one or more of exemplary depth map component 108, exemplary edge map component 110, exemplary finger identification component 112, exemplary touch tracking component 114, exemplary UI component 116, exemplary display component 118, functionality, portions, combinations, or sub combinations thereof, as further described herein.

In addition, device or system 1700 comprising exemplary non-limiting touch tracking devices or systems 102, or portions thereof, can comprise one or more memories and/or storage components (e.g., one or more exemplary data store(s) 120, or otherwise, etc.) to store computer-executable components (e.g., one or more of exemplary depth map component 108, exemplary edge map component 110, exemplary finger identification component 112, exemplary touch tracking component 114, exemplary UI component 116, exemplary display component 118, depth segmentation component 1602, pixel identification component 1604, and/or analysis component 1606, and/or other complementary and/or ancillary components or subcomponents, etc.) and/or one or more processors communicatively coupled to the memory that facilitates execution of the computer-executable components, for example, as further described herein.

Thus, FIG. 17 illustrates an example non-limiting device or system 1700 suitable for performing various aspects of the disclosed subject matter. As described above with reference to FIGS. 1 and 16, for example, various non-limiting embodiments of the disclosed subject matter can comprise more or less functionality than those example devices or systems described therein, depending on the context. In addition, a device or system 1700 as described can be any of the devices and/or systems as the context requires and as further described above in connection with FIGS. 1-16, for example. It can be understood that while the functionality of device or system 1700 is described in a general sense, more or less of the described functionality may be implemented, combined, and/or distributed (e.g., among network components, servers, databases, and the like), according to context, system design considerations, and/or marketing factors, and the like. For the purposes of illustration and not limitation, example non-limiting devices or systems 1700 can comprise one or more example devices and/or systems of FIG. 1, such as exemplary non-limiting touch tracking devices or systems 102 as described herein, for example, or portions thereof.

To these and related ends, one or more processors 1704 can be associated with any number of computer-executable components (e.g., one or more of exemplary depth map component 108, exemplary edge map component 110, exemplary finger identification component 112, exemplary touch tracking component 114, exemplary UI component 116, exemplary display component 118, depth segmentation component 1602, pixel identification component 1604, and/or analysis component 1606, and/or other complementary and/or ancillary components or subcomponents, etc.) to facilitate functionality described herein. In a non-limiting example, device or system 1700 comprising exemplary non-limiting touch tracking devices or systems 102, or portions thereof, can facilitate, among other things, analyzing information associated with one or more images, image streams, portions thereof, derivative information, performing one or more analyses, determining results of the one or more analyses, and/or generate results, reports, inferences, and/or recommendations, compose and/or respond to requests or queries, etc., for example, as further described herein, regarding FIGS. 1-16, etc., without limitation to system requirements such as device type (e.g., desktop, tablet, smartphone, etc.), operating system specification (e.g., brand/or type and version, such as Windows® 10, Android™ 3.0, etc.), device hardware or software specification (e.g., RAM, hard disk, Internet browser, etc.), and/or data, information, and/or attributes relating thereto, etc.

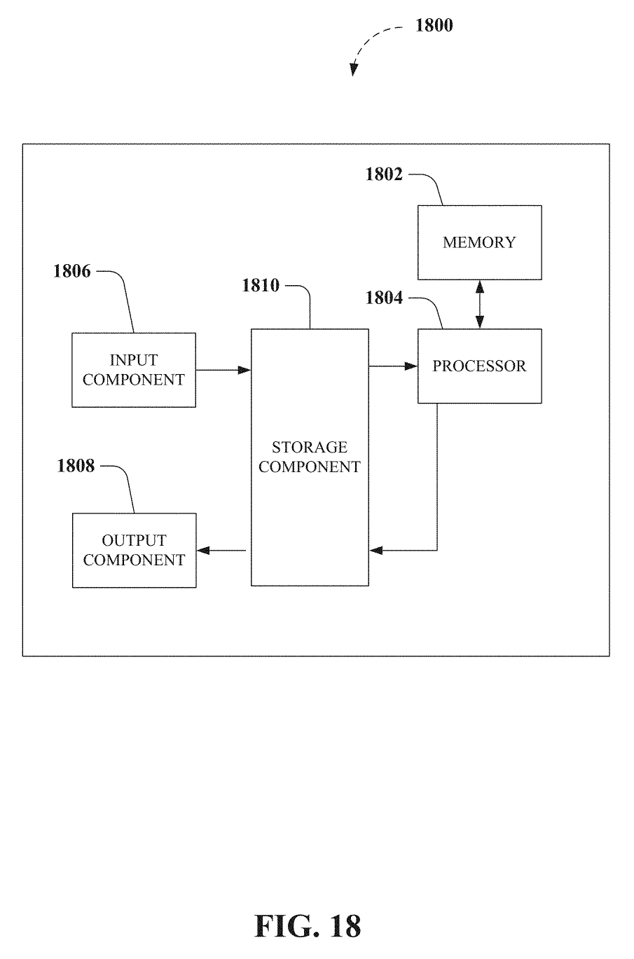

As further described above regarding FIGS. 18 and 27-28, for example, device or system 1700 comprising exemplary non-limiting touch tracking devices or systems 102 as described herein, for example, or portions thereof, can comprise further components (not shown) (e.g., authentication, authorization and accounting (AAA) servers, e-commerce servers, database servers, application servers, etc.) and/or sub-components in communication with exemplary non-limiting touch tracking devices or systems 102 as described herein, for example, or portions thereof, to accomplish the desired functions, whether complementary, ancillary, or otherwise, without limitation.

As a non-limiting example, in an example implementation, device or system 1700 comprising exemplary non-limiting touch tracking devices or systems 102 as described herein, for example, or portions thereof, can further comprise a authentication component that can solicit authentication data via exemplary UI component 116 (e.g., via an operating system, and/or application software, etc.) on behalf of a user, or otherwise, and, upon receiving authentication data so solicited, can be employed, individually and/or in conjunction with information acquired and ascertained as a result of biometric modalities employed (e.g., facial recognition, voice recognition, etc.), verifying received authentication data, and so on. The authentication data can be in the form of a password (e.g., a sequence of humanly cognizable characters), a pass phrase (e.g., a sequence of alphanumeric characters that can be similar to a typical password but is conventionally of greater length and contains non-humanly cognizable characters in addition to humanly cognizable characters), a pass code (e.g., Personal Identification Number (PIN)), encryption key, and so on, for example.

Additionally and/or alternatively, public key infrastructure (PM) data can also be employed by authentication component. PKI arrangements can provide for trusted third parties to vet, and affirm, entity identity through the use of public keys that typically can be certificates issued by trusted third parties. Such arrangements can enable entities to be authenticated to each other, and to use information in certificates (e.g., public keys) and private keys, session keys, Traffic Encryption Keys (TEKs), cryptographic-system-specific keys, and/or other keys, to encrypt and decrypt messages communicated between entities.

Accordingly, an example authentication component can implement one or more machine-implemented techniques a user of exemplary UI component 116 (e.g., via an operating system and/or application software) on behalf of the user, by the user's unique physical and behavioral characteristics and attributes. Biometric modalities that can be employed can comprise, for example, face recognition wherein measurements of key points on an entity's face can provide a unique pattern that can be associated with the entity, iris recognition that measures from the outer edge towards the pupil the patterns associated with the colored part of the eye—the iris—to detect unique features associated with an entity's iris, voice recognition, and/or finger print identification that scans the corrugated ridges of skin that are non-continuous and form a pattern that can provide distinguishing features to identify an entity. Moreover, any of the components described herein (e.g., authentication component, etc.) can be configured to perform the described functionality (e.g., via computer-executable instructions stored in a tangible computer readable medium, and/or executed by a computer, a processor, etc.).

In other non-limiting implementations, device or system 1700 comprising exemplary non-limiting touch tracking devices or systems 102 as described herein, for example, or portions thereof, can also comprise a cryptographic component that can facilitate encrypting and/or decrypting data and/or information associated with exemplary non-limiting touch tracking devices or systems 102 as described herein or portions thereof, to protect such sensitive data and/or information associated with a user of exemplary UI component 116, such as authentication data, etc. Thus, one or more processors can be associated with a cryptographic component. In accordance with an aspect of the disclosed subject matter, a cryptographic component can provide symmetric cryptographic tools and accelerators (e.g., Twofish, Blowfish, AES, TDES, IDEA, CASTS, RC4, etc.) to facilitate encrypting and/or decrypting data and/or information associated with exemplary UI component 116.

Thus, an example cryptographic component can facilitate securing data and/or information being written to, stored in, and/or read from a storage component (e.g., exemplary data store(s) 120, or otherwise, etc.), transmitted to and/or received from a connected network to ensure that protected data can only be accessed by those entities authorized and/or authenticated to do so. To the same ends, a cryptographic component can also provide asymmetric cryptographic accelerators and tools (e.g., RSA, Digital Signature Standard (DSS), and the like) in addition to accelerators and tools (e.g., Secure Hash Algorithm (SHA) and its variants such as, for example, SHA-0, SHA-1, SHA-224, SHA-256, SHA-384, SHA-512, SHA-3, and so on). As described, any of the components described herein (e.g., cryptographic component, etc.) can be configured to perform the described functionality (e.g., via computer-executable instructions stored in a tangible computer readable medium, and/or executed by a computer, a processor, etc.).

For still other non-limiting implementations, device or system 1700 comprising exemplary non-limiting touch tracking devices or systems 102 as described herein, for example, or portions thereof, can also comprise a storage component (e.g., (e.g., exemplary data store(s) 120, or otherwise, which can comprise one or more of a local storage component, a network storage component, a memory, other storage components or subcomponents, etc.) that can facilitate storage and/or retrieval of data and/or information associated with exemplary non-limiting touch tracking devices or systems 102. Thus, as described above, exemplary non-limiting touch tracking devices or systems 102, or portions thereof, exemplary finger identification component 112, exemplary touch tracking component 114, etc. comprising device or system, 1700, and so on, or portions thereof, can comprise one or more processors that can be associated with a storage component to facilitate storage of data and/or information, and/or instructions for performing functions associated with and/or incident to the disclosed subject matter as described herein, for example, regarding FIGS. 1-16, etc.

It can be understood that a storage component can comprise one or more computer executable components as described herein, and/or portions thereof, to facilitate any of the functionality described herein and/or ancillary thereto, such as by execution of computer-executable instructions by a computer, a processor, etc. (e.g., one or more processors, etc.). Moreover, any of the components described herein (e.g., a storage component, etc.) can be configured to perform the described functionality (e.g., via computer-executable instructions stored in a tangible computer readable medium, and/or executed by a computer, a processor, etc.).

It should be noted that, as depicted in FIG. 17, devices or systems 1700 are described as monolithic devices or systems. However, it is to be understood that the various components and/or the functionality provided thereby can be incorporated into one or more processors or provided by one or more other connected devices or systems, for example, as described herein, regarding FIGS. 16, 27-28, etc. Accordingly, it is to be understood that more or less of the described functionality may be implemented, combined, and/or distributed (e.g., among network devices or systems, servers, databases, and the like), according to context, system design considerations, and/or marketing factors. Moreover, any of the components described herein can be configured to perform the described functionality (e.g., via computer-executable instructions stored in a tangible computer readable medium, and/or executed by a computer, a processor, etc.).

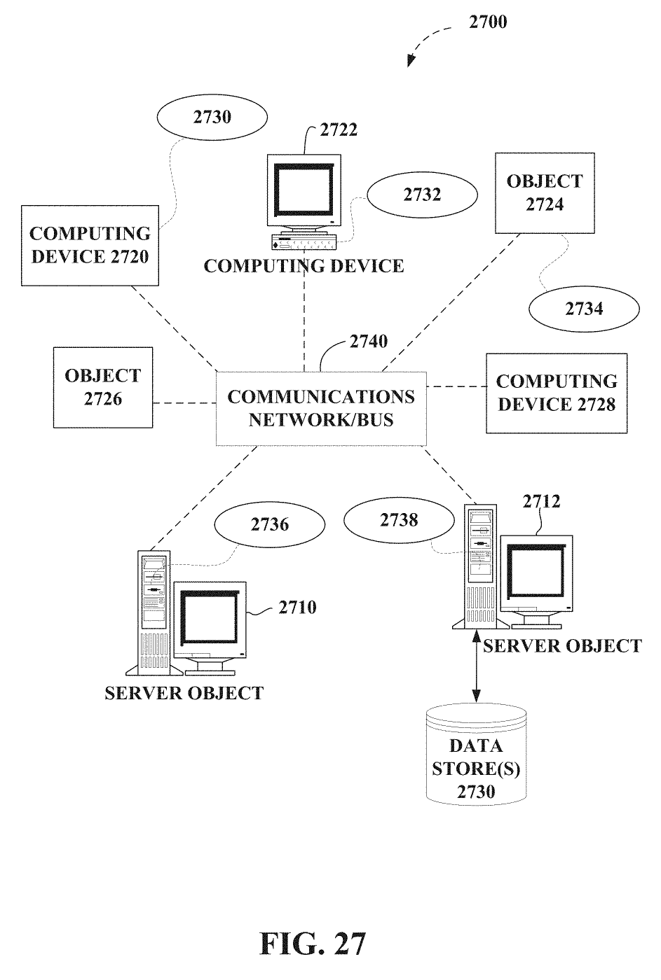

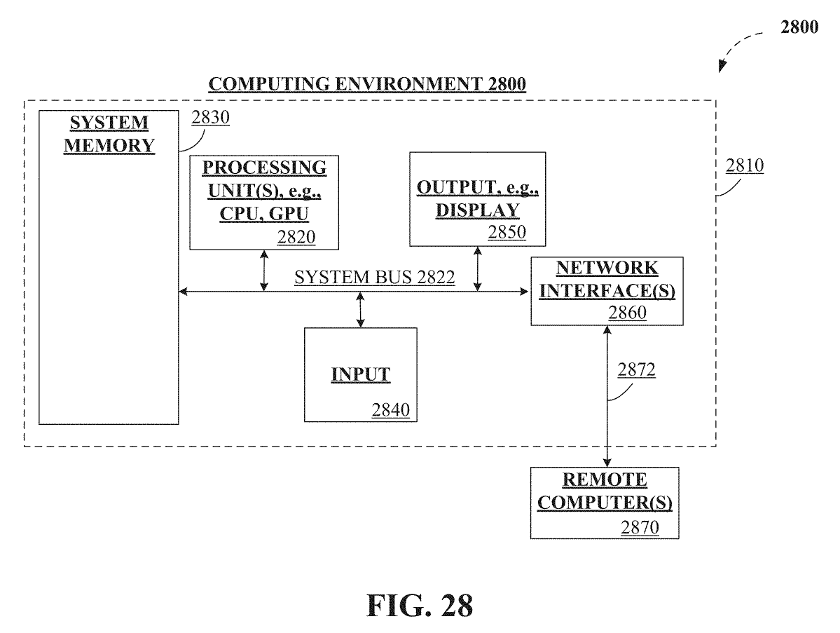

FIG. 18 illustrates an example non-limiting device or system 1800 suitable for performing various aspects of the disclosed subject matter. The device or system 1800 can be a stand-alone device or a portion thereof, a specially programmed computing device or a portion thereof (e.g., a memory retaining instructions for performing the techniques as described herein coupled to a processor), and/or a composite device or system comprising one or more cooperating components distributed among several devices, as further described herein. As an example, example non-limiting device or system 1800 can comprise example devices and/or systems regarding FIGS. 1-17, as described above, or as further described below regarding FIGS. 27-28, for example, or portions thereof. For example, FIG. 18 depicts an example device 1800, such as exemplary non-limiting touch tracking devices or systems 102, or portions thereof, exemplary finger identification component 112, exemplary touch tracking component 114, etc. comprising device or system, 1700, and so on, or portions thereof.

Accordingly, device or system 1800 can comprise a memory 1802 that retains various instructions with respect to facilitating various operations, for example, such as providing functionality for, implementing the methods, procedures, algorithms, or portions thereof, as described herein, regarding FIGS. 1-18; encryption; decryption; providing various user or device interfaces; and/or communications routines such as networking, and/or the like. For instance, device or system 1800 can comprise a memory 1802 that retains instructions for providing functionality for, implementing the methods, procedures, algorithms, or portions thereof, as described herein, regarding FIGS. 4-5, 8-11, 15, as further described above regarding FIGS. 16-17, for example.

In a non-limiting example, memory 1802 can retain instructions for receiving (e.g., by exemplary touch tracking system 102, portions thereof, etc.) depth image information 502 associated with a surface and arm positions, hand positions, or finger positions associated with a user and relative to the surface, for example, as further described above regarding FIGS. 1, 4-5, etc. In addition, in further example implementations, memory 1802 can retain instructions for computing (e.g., by exemplary touch tracking system 102, portions thereof, etc.) a depth map 508 based on the depth image information 502, for example, as described above regarding FIGS. 1, 4-5, etc. Additionally, memory 1802 can retain instructions for receiving (e.g., by exemplary touch tracking system 102, portions thereof, etc.) infrared image information 510 associated with the arm positions, the hand positions, or the finger positions, wherein the infrared image information 510 is registered with the depth image information 508, as described above regarding FIGS. 1, 4-5, etc.

In further example implementations, memory 1802 can retain instructions for computing (e.g., by exemplary touch tracking system 102 portions thereof, etc.) an edge map 520, edge map information, etc. (e.g., based on the infrared image information 510, based on the depth image information 502, etc.), for example, as described above regarding FIGS. 1, 4-5, etc. In still further example implementations, memory 1802 can retain instructions for determining (e.g., by exemplary touch tracking system 102, exemplary finger identification component 112, portions thereof, etc.) one or more finger position of the finger positions relative to the surface, based on the depth map 508 as constrained in part by the edge map 520, edge map information, etc., and anthropometric data 804 related to the arm positions, the hand positions, or the finger positions relative to the surface, for example, as described above regarding FIGS. 1, 4-5, 8-11, etc. In another non-limiting example, memory 1802 can retain instructions for determining (e.g., by exemplary touch tracking system 102, exemplary finger identification component 112, portions thereof, etc.) that a touch of the surface has occurred by comparing a distance above the surface of the finger position against a touch threshold, for example, as described above regarding FIGS. 1, 4-5, 8-11, etc.

The above example instructions and other suitable instructions for functionalities as described herein, for example, regarding FIGS. 1-16, 19, 27-28, etc., can be retained within memory 1802, and a processor 1804 can be utilized in connection with executing the instructions.

In addition, non-limiting device or system 1800 can comprise an input component 1806 that can be configured to receive data or signals, and perform typical actions thereon (e.g., transmits to storage component 1810, one or more exemplary data store(s) 120, etc.) the received data or signal. A storage component 1810 can store the received data or signal, as described above, for example, regarding a storage component, memory 1702, etc., for subsequent processing or can provide it to one or more of depth segmentation component 1602, pixel identification component 1604, and/or analysis component 1606, and/or functionality, portions, combinations, and/or sub combinations thereof, as well as one or more of exemplary depth map component 108, exemplary edge map component 110, exemplary finger identification component 112, exemplary touch tracking component 114, exemplary UI component 116, exemplary display component 118, functionality, portions, combinations, or sub combinations thereof, or a processor (e.g., one or more processors 1704, etc.), via a memory (e.g., memory 1702, etc.) over a suitable communications bus or otherwise, or to the output component 1808.

Processor 1804 can be a processor dedicated to analyzing and performing functions on information received by input component 1802 and/or generating information for transmission by an output component 1808. Processor 1804 can be a processor that controls one or more portions of system or device 1800, and/or a processor that analyzes information received by input component 1802, generates information for transmission by output component 1808, and performs various decoding algorithms of decoding component 1806. It can be understood that various routines performed by system or device 1800 can utilize artificial intelligence based methods in connection with performing inference and/or probabilistic determinations and/or statistical-based determinations in connection with various aspects of the disclosed subject matter.

System or device 1800 can additionally comprise a memory 1802 (e.g., memory 1702, etc.) that is operatively coupled to processor 1804 and that stores information such as described above, parameters, information, and the like, wherein such information can be employed in connection with implementing various aspects as described herein. Memory 1802 can additionally store received data and/or information (e.g., data and/or information associated with exemplary touch tracking devices or systems 102, etc.), as well as software routines and/or instructions for functionality as described above in reference to FIGS. 2-17, etc., for example. In yet other non-limiting implementations, example device 1800 can comprise means for communicating information (e.g., one or more packets or other data or signals representing voice information, textual information, visual information such as UI, etc.); means for encryption; means for decryption; means for providing various user or device interfaces; and/or means for communicating via communications routines such as networking, and/or peer-to-peer communications routines, and/or the like.

It will be understood that storage component 1810, exemplary data store(s) 120, or other storage component, memory 1702, memory 1802, and/or any combination thereof as described herein can be either volatile memory or nonvolatile memory, or can comprise both volatile and nonvolatile memory. By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1802 is intended to comprise, without being limited to, these and/or any other suitable types of memory, including processor registers and the like. In addition, by way of illustration and not limitation, storage component 1810 and/or a storage component, can comprise conventional storage media as in known in the art (e.g., hard disk drive, solid state disk (SSD), etc.).

It can be understood that various techniques described herein may be implemented in connection with hardware or software or, where appropriate, with a combination of both. As used herein, the terms “device,” “component,” “system” and the like are likewise intended to refer to a computer-related entity, either hardware, a combination of hardware and software, software, or software in execution. For example, a “device,” “component,” subcomponent, “system” portions thereof, and so on, may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

It can be further understood that while a brief overview of example systems, methods, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used or modifications and additions can be made to the described embodiments for performing the same or equivalent function of the corresponding embodiments without deviating therefrom.

As can be understood, in example implementations of the disclosed subject matter, various interfaces such as device interfaces, user interfaces such as GUIs, and so on can be provided, for example to facilitate touch tracking embodiments according to various aspects of the disclosed subject matter, among other related functions. In addition, additional embodiments of the disclosed subject matter can provide computer-executable components that can be stored on a tangible computer readable storage medium (e.g., a storage component, storage component 1810, memory 1702, 1802, etc.), and that, in response to execution by a computing device (e.g., one or more processors, processor 1704, 1804, etc.), can cause the computing device to display information (e.g., on the computing device, on a remote computing device over a network, etc.), for example, such as via a GUI, in addition to upon ordinary, arbitrary and/or ad hoc surfaces, as described herein. For example, FIG. 18 illustrates an example non-limiting block diagram depicting tangible computer readable storage medium, such as storage component 1810 (e.g., a storage component, exemplary data store(s) 120, memory 1702, etc.), that can comprise computer-executable components and that, in response to execution by a computing device (e.g., one or more processors, processor 1704, 1804, etc.), can cause the computing device to display information (e.g., on the computing device, on a remote computing device over a network, etc.), in addition to upon ordinary, arbitrary and/or ad hoc surfaces, as described herein. In any event, the computer-executable components of the tangible computer readable storage medium can provide a user interface, such as via UI component 116, or other interfaces to facilitate interactions with exemplary touch tracking devices or systems 102, as described herein.

FIG. 19 depicts further non-limiting aspects of an exemplary implementation 1900 as described herein, which depicts a Kinect™ 2 depth camera 1902 mounted 1.6 m from the table 1904 surface. It is noted that the projector 1906 and Kinect™ 2 are rigidly mounted and calibrated to each other (but not calibrated to the surface). FIG. 19 depicts the table 1904 surface functioning as a touchscreen 1908, with robust touch tracking, according to various aspects described herein, for example, as further discussed below.

### Example Touch Tracking Comparitive Results

Note that in some instances a static background was used to avoid unexpected shifts in the background, in part because some of the experimental tasks required the user to hold his or her hand still, which could cause a dynamic background to incorrectly integrate the user into the background. The performance of a particular non-limiting example described herein (e.g., DIRECT) system was assessed by implementing four broad classes of conventional depth-camera-based, touch tracking methods as described above regarding FIGS. 2-3, wherein the particular non-limiting implementation of DIRECT is labeled “0” (202), wherein the single frame background model is labeled “1” (204), wherein the maximum distance background model is labeled “2” (206) (overlapping “1” (204) in FIG. 2), wherein the statistical background model is labeled “3” (208) (overlapping “1” (204) or lightly displayed in FIG. 2), wherein slice finding and merging is labeled “4” (210). These conventional methods were developed using the predecessor of the present system (Kinect™ 2), Kinect™. As opposed to the unstructured illumination as described herein, the Kinect™ sensor uses structured light, which projects an infrared speckle pattern onto the scene, as opposed to the time-of-flight approach used in the Kinect™ 2, wherein the speckle pattern renders the infrared image virtually unusable for tracking, precluding DIRECT-style sensing. The previous Kinect™ features both lower depth image pixel resolution (320×240 rescaled to 640×480) and lower depth resolution (approximately 4 mm per depth unit at a distance of 2 meters) than the Kinect™ 2. Accordingly, it was necessary to adjust and tune the comparison techniques to work with the new sensor, but none of the conventional methods were originally designed to operate at the distance employed here.

To compare the accuracy of the subject disclosure, an evaluation with 12 users (e.g., 3 female, average age 25) was conducted, all of whom were familiar with the use of touch interfaces. Participants were simply told that the table surface was a touchscreen from the outset, and to touch the surface as they would any ordinary touchscreen, were permitted to use either hand (interchangeably), were permitted to use any finger pose they found comfortable. Users were not required to remove jewelry or roll up sleeves, and some users conducted the study while wearing long sleeved shirts, bracelets and watches. The experimental system continuously ran the particular non-limiting implementation of DIRECT touch tracker alongside all four of our comparison methods, and all methods ran at a constant 30 fps (e.g., the frame rate of the depth sensor).

Participants were asked to complete a series of 14 tasks, organized into three categories, wherein task order was randomized per user to avoid order effects. For each task, users were instructed to stand along one of the two long edges of the table, to change the orientation of their touch and seven tasks were performed for each table edge.

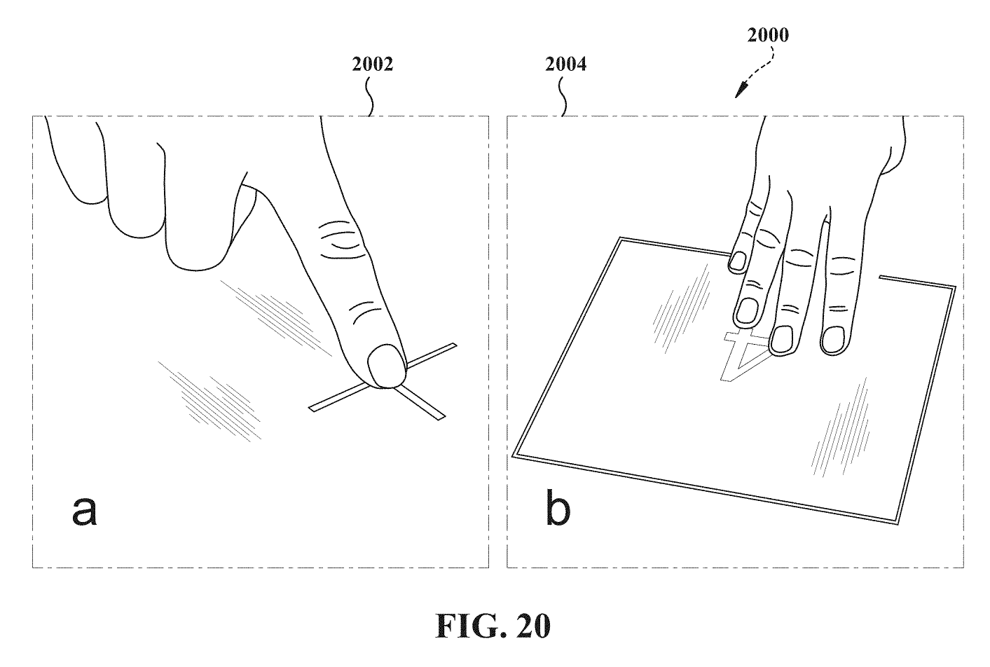

For instance, FIG. 20 demonstrates exemplary touch tracking tasks 2002, 2004 employed to facilitate comparison of depth-camera-based touch tracking methods as described herein. In the crosshair task 2002, participants placed their fingertip on a projected crosshair, after which the experimenter manually advanced the trial and the touches detected by each tracker were recorded, to measure the accuracy and stability of each touch tracking method. Crosshairs were arranged in a 4×8 grid spanning the table surface, but were presented in random order, and for each task instance, users touched each crosshair once. There were two instances of crosshair task 2002 per table edge.

In the multitouch box task 2004, participants were instructed to place a specific number of fingers within a projected 20 cm square on the table, and the experimenter then manually advanced the trial and the number of touches reported within the box for each tracker was recorded, to measure the multitouch contact reporting accuracy of each technique (i.e., false positive and false negative touches). Six boxes were specified across the length of the table, and the number of fingers varied from 1-5 for a total of 30 trials, randomly ordered. There were two multitouch box task 2004 instances per table edge.

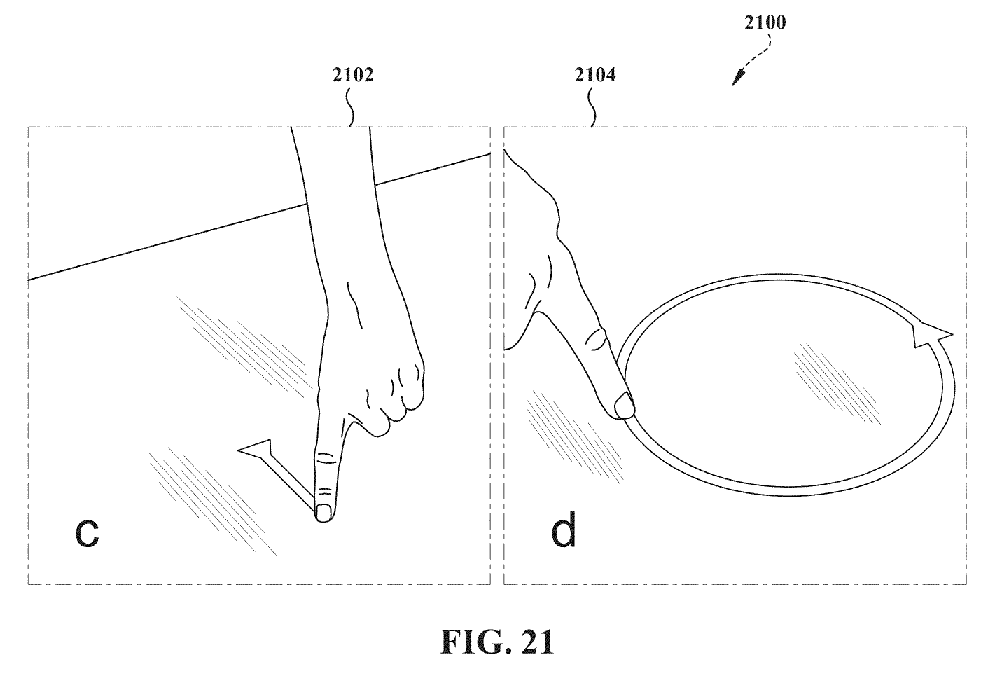

FIG. 21 demonstrates further exemplary touch tracking tasks 2102, 2104 employed to facilitate comparison of depth-camera-based touch tracking methods as described herein. In the shape tracing tasks 2102, 2104, participants were instructed to trace a particular projected shape (line shape task 2102, circle shape task 2104), starting at the start position indicated with a green triangle and tracing along the shape to the end. Start and end conditions were detected automatically using the particular non-limiting implementation of DIRECT. For each frame between the start and end of the trial, touch coordinates from the particular non-limiting implementation of DIRECT only (without other tracker data) were recorded to replicate the tracing task found in conventional research, and to enable direct comparisons between the subject disclosure and conventional results. Thus, for parity, visual feedback was shown to the user as the user traced the path, and three instances of this task per table edge were performed, one for each shape (i.e., horizontal line, vertical line, and circle).

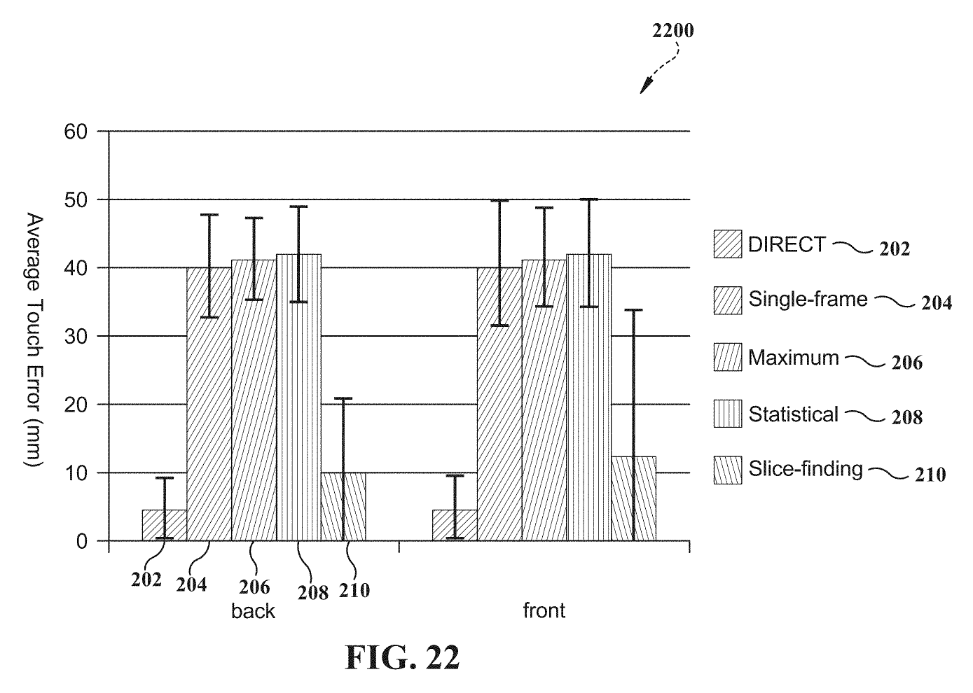

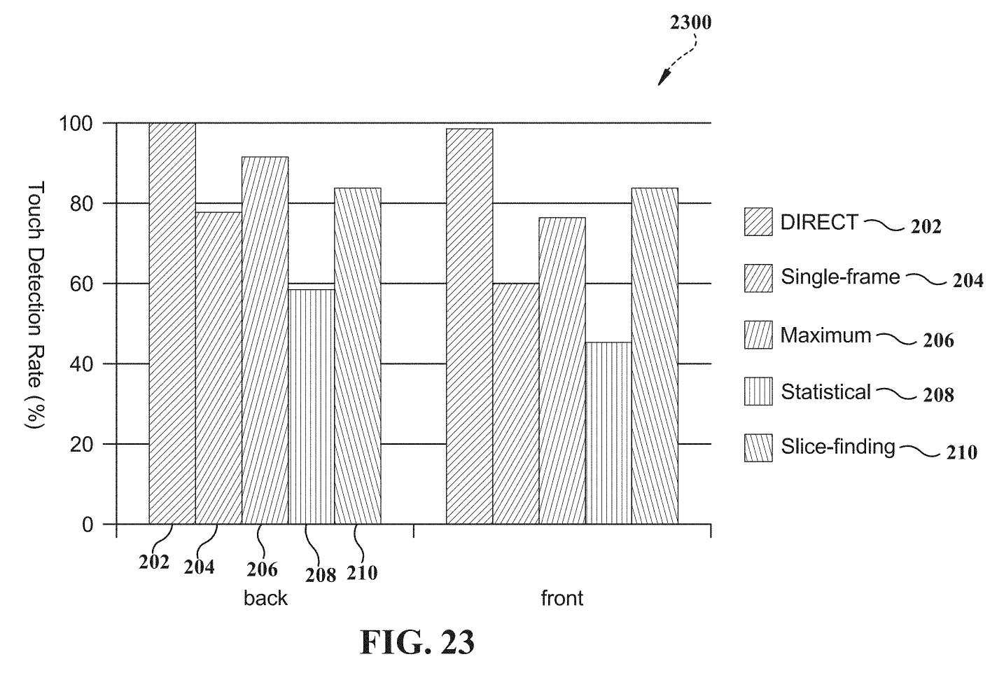

FIGS. 22-23 shows summary plots of the average touch error and touch detection rate for each of five touch tracking methods. Results tabulated note the two sides of the table “back” and “front,” where the Kinect™ 2 was mounted such that the top of the Kinect™ 2 image corresponded to the front side of the table. In the crosshair task 2002, both touch accuracy and touch detection rate were tested. Due to potential spuriously detected touches, measured accuracy was recorded as the mean distance from the finger to the nearest detected touch point for each touch tracker. Touches further than 200 mm from the finger were not counted, since those touches would clearly be erroneous. If no touches were detected in range for a particular tracker, the tracker was considered to have failed to detect the touch. In total, 768 trials for each side of the table were collected. FIG. 22 demonstrates average touch positional error for five described touch tracking methods, and FIG. 23 demonstrates exemplary touch detection rate for five described touch tracking methods, where the error bars depict standard error. The accuracy results show a slight but consistent increase in accuracy across all trackers when users stood at the front side of the table.

The particular non-limiting implementation of DIRECT (202) achieved an average Euclidean-distance positional error of 4.8 mm across all trials, with a 99.3% touch detection rate. The next best technique, slice finding 210, had an average positional error of 11.1 mm and a touch detection rate of 83.9%. The background modeling methods (204, 206, 208) all performed quite poorly, with average positional errors of over 40 mm and touch detection rates ranging from 52.1% to 84.8%, which indicates that these methods do not have the necessary sophistication to segment small finger contacts at the noise level present when sensing at 1.6 meters.

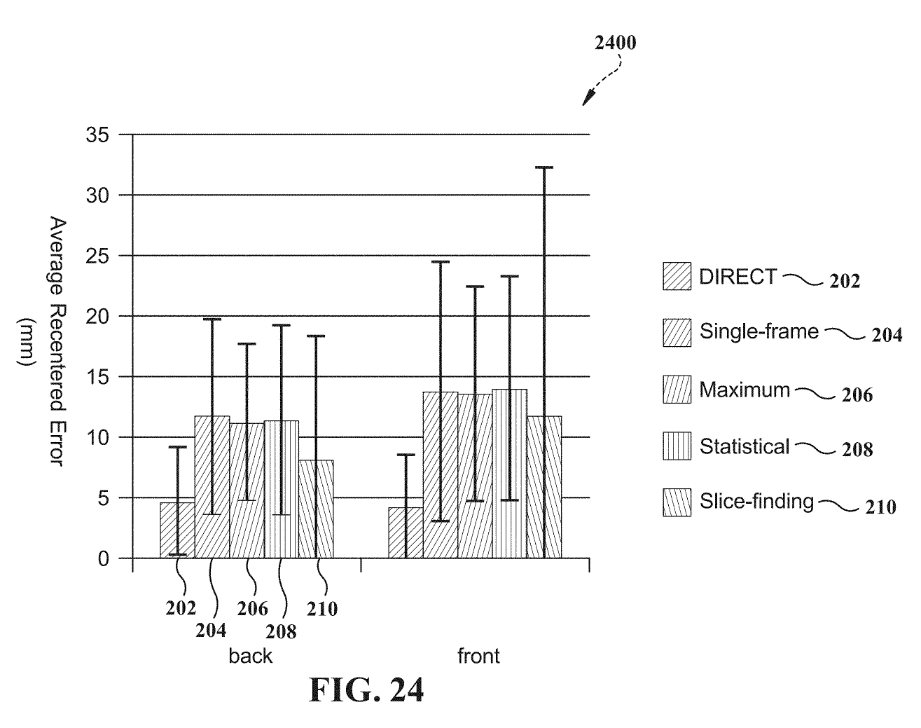

FIG. 24 demonstrates average positional error after removing the average offset vector and assuming a priori knowledge of the user's orientation, where error bars depicts standard error. It was noted that the slice finding 210 method without forward projection performed very poorly (e.g., approximately 20 mm average error), so it was clear that finger forward projection was crucial to obtain good accuracy. This is because these methods cannot accurately locate the fingertip in the noise, and so they instead locate a point somewhere along the finger. Thus, accuracy of the four competing approaches was analyzed by applying a mean offset vector (i.e., a post hoc global offset). This vector depends on knowing the precise finger orientation, and thus the offset correction corresponds to a “calibrating” of the touch algorithm from a fixed user position and assuming the finger is extended perpendicular to the table. Consequently, offsets were computed separately for the front and back user positions. While conventional systems recognize neither the user position nor finger orientation, this can serve as a useful benchmark.

The resulting average offset-corrected errors in FIG. 24 were 4.46 mm for the particular non-limiting implementation of DIRECT (202) (e.g., a negligible 0.3 mm improvement), 9.9 mm for the slice finding method 210 (e.g., a modest 1.2 mm improvement), and 12.3-12.7 mm for the back-ground modeling approaches 204, 206, 208 (e.g., a significant 20-30 mm improvement).

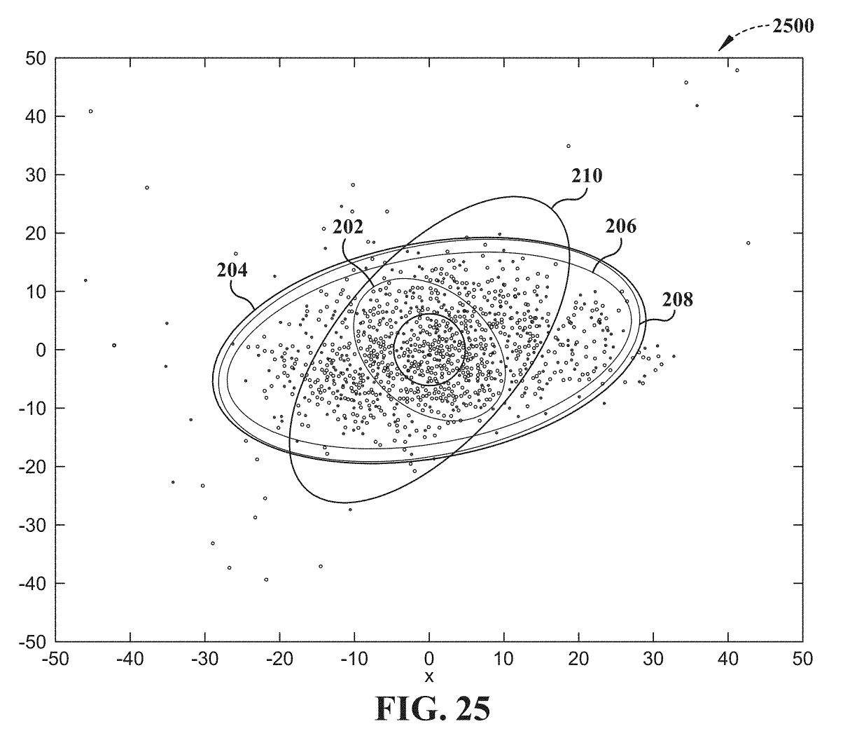

To visualize these errors, the 95% confidence ellipsoids were computed FIG. 25 for each tracker (note that the offset correction corresponds to recentering the ellipsoids). These errors are consistent with prior conventional results suggesting that our offset-corrected comparison implementations are reasonably close to the original implementations.

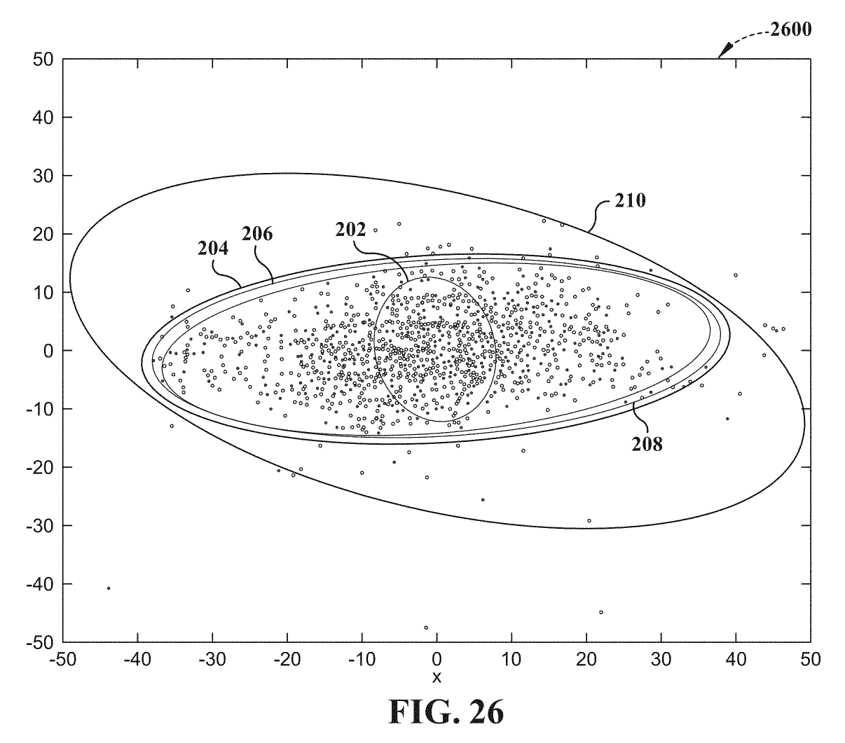

FIG. 25 demonstrates 95% confidence ellipses for the crosshair task from the back of the table, for crosshair task 2002, FIG. 26 demonstrates 95% confidence ellipses for the crosshair task 2002 from the front of the table, where X and Y axis units are in millimeters.

The multitouch box tasks 2004 measured false positive and false negative rates for touch detection with multiple fingers present. Under these conditions, touch trackers might merge adjacent fingers or detect spurious touches between existing fingers. Differences between the back and front sides were not significant in this task, so the results have been combined. In total, 1440 trials were collected. Detecting a single extended finger is the easiest task. In single finger trials, particular non-limiting implementation of DIRECT (202) detected the correct number 95.8% of the time. Single-frame background 204, maximum frame background 206, and statistical model background 208 achieved 52.8%, 66.3% and 35.1% respectively. Slice finding 210 was 75.0% accurate. Detecting several fingers in close proximity is much more challenging when sensing at 1.6 meters.

The particular non-limiting implementation of DIRECT (202) detected the correct number of fingers in 1088 trials (75.5%), more fingers than were present in 34 trials (2.4%), and fewer fingers than were present in 318 trials (22.1%). The three background modeling approaches, single-frame 204, maximum frame 206, and statistical model 208, detected the correct number of fingers in 321 (22.2%), 421 (29.2%) and 249 (17.3%) trials, more fingers in 9, 7, and 4 trials, and fewer fingers in 1110, 1012, and 1187 trials, respectively. Finally, the slice-finding 210 approach detected more fingers in 9 trials and fewer fingers in 1086 trials, correctly counting the number of fingers in 345 (24.0%) trials.

While comparison technique implementations were tuned to minimize spurious touches while nothing was touching the table, multitouch segmentation results for the particular non-limiting implementation of DIRECT (202) suggest that optimizing for this criterion could have rejected too many legitimate touches, reducing touch detection rates. On the other hand, increasing touch sensitivity significantly increases noise and errant touches. For example, decreasing the “low boundary” depth threshold in the maximum distance background model tracker by a single millimeter results in an unacceptable rate of hundreds of errant touches detected on the surface every second.

Due to tracking stability issues for the competing approaches, it was not possible to test their shape tracing tasks 2102, 2104, ability. Instead, results reported for OmniTouch can be used as one point of comparison. Specifically, OmniTouch achieves a mean error of 6.3 mm (SD=3.9 mm) at a sensing distance of 40 centimeters on a flat notepad. For comparison, the particular non-limiting implementation of DIRECT (202) achieves a mean error (across all 864 trials) of 2.9 mm (mean SD=2.7 mm) at a sensing distance of 160 centimeters.

In summary, particular non-limiting implementation of DIRECT (202) demonstrates greatly improved touch accuracy (mean error 4.9 mm) and detection rate (>99%) over competing techniques. The particular non-limiting implementation of DIRECT (202) outputs integer coordinates on the depth map, which quantizes the X/Y position to 4.4 mm intervals. Sub pixel accuracy could thus further improve the accuracy of particular the non-limiting implementation of DIRECT (202), especially in conjunction with some level of touch point smoothing, in further non-limiting aspects. In one exemplary implementation described herein, DIRECT enables the creation of a precise 2.3 m-diagonal touchscreen on an ordinary unmodified wood table, using only commercially available commodity hardware. The study examining the accuracy, reliability and precision of DIRECT compared to other methods demonstrated that the particular non-limiting implementation of DIRECT (202) indeed provides high accuracy touch tracking on unmodified surfaces.

### Example Networked and Distributed Environments

One of ordinary skill in the art can appreciate that the various embodiments of the disclosed subject matter and related systems, devices, and/or methods described herein can be implemented in connection with any computer or other client or server device, which can be deployed as part of a communications system, a computer network, and/or in a distributed computing environment, and can be connected to any kind of data store. In this regard, the various embodiments described herein can be implemented in any computer system or environment having any number of memory or storage units, and any number of applications and processes occurring across any number of storage units or volumes, which may be used in connection with communication systems using the techniques, systems, and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving, storing, and/or transmitting information in connection with remote or local services and processes.

Distributed computing provides sharing of computer resources and services by communicative exchange among computing devices and systems. These resources and services can include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices can have applications, objects or resources that may utilize disclosed and related systems, devices, and/or methods as described for various embodiments of the subject disclosure.

FIG. 27 provides a schematic diagram of an example networked or distributed computing environment. The distributed computing environment comprises computing objects 2710, 2712, etc. and computing objects or devices 2720, 2722, 2724, 2726, 2728, etc., which may include programs, methods, data stores, programmable logic, etc., as represented by applications 2730, 2732, 2734, 2736, 2738. It can be understood that objects 2710, 2712, etc. and computing objects or devices 2720, 2722, 2724, 2726, 2728, etc. may comprise different devices, such as PDAs, audio/video devices, mobile phones, MP3 players, personal computers, laptops, etc.

Each object 2710, 2712, etc. and computing objects or devices 2720, 2722, 2724, 2726, 2728, etc. can communicate with one or more other objects 2710, 2712, etc. and computing objects or devices 2720, 2722, 2724, 2726, 2728, etc. by way of the communications network 2740, either directly or indirectly. Even though illustrated as a single element in FIG. 27, network 2740 may comprise other computing objects and computing devices that provide services to the system of FIG. 27, and/or may represent multiple interconnected networks, which are not shown. Each object 2710, 2712, etc. or 2720, 2722, 2724, 2726, 2728, etc. can also contain an application, such as applications 2730, 2732, 2734, 2736, 2738, that can make use of an API, or other object, software, firmware and/or hardware, suitable for communication with or implementation of disclosed and related systems, devices, methods, and/or functionality provided in accordance with various embodiments of the subject disclosure. Thus, although the physical environment depicted may show the connected devices as computers, such illustration is merely example and the physical environment may alternatively be depicted or described comprising various digital devices, any of which can employ a variety of wired and/or wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many networks are coupled to the Internet, which can provide an infrastructure for widely distributed computing and can encompass many different networks, though any network infrastructure can be used for example communications made incident to employing disclosed and related systems, devices, and/or methods as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 27, as a non-limiting example, computers 2720, 2722, 2724, 2726, 2728, etc. can be thought of as clients and computers 2710, 2712, etc. can be thought of as servers where servers 2710, 2712, etc. provide data services, such as receiving data from client computers 2720, 2722, 2724, 2726, 2728, etc., storing of data, processing of data, transmitting data to client computers 2720, 2722, 2724, 2726, 2728, etc., although any computer can be considered a client, a server, or both, depending on the circumstances. Any of these computing devices may be processing data, forming metadata, synchronizing data or requesting services or tasks that may implicate disclosed and related systems, devices, and/or methods as described herein for one or more embodiments.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to disclosed and related systems, devices, and/or methods can be provided standalone, or distributed across multiple computing devices or objects.

In a network environment in which the communications network/bus 2740 is the Internet, for example, the servers 2710, 2712, etc. can be Web servers with which the clients 2720, 2722, 2724, 2726, 2728, etc. communicate via any of a number of known protocols, such as the hypertext transfer protocol (HTTP). Servers 2710, 2712, etc. may also serve as clients 2720, 2722, 2724, 2726, 2728, etc., as may be characteristic of a distributed computing environment.

### Example Computing Device

As mentioned, advantageously, the techniques described herein can be applied to devices or systems where it is desirable to employ disclosed and related systems, devices, and/or methods. It should be understood, therefore, that handheld, portable and other computing devices and computing objects of all kinds are contemplated for use in connection with the various disclosed embodiments. Accordingly, the below general purpose remote computer described below in FIG. 28 is but one example of a computing device. Additionally, disclosed and related systems, devices, and/or methods can include one or more aspects of the below general purpose computer, such as display, storage, analysis, control, etc.

Although not required, embodiments can partly be implemented via an operating system, for use by a developer of services for a device or object, and/or included within application software that operates to perform one or more functional aspects of the various embodiments described herein. Software can be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 28 thus illustrates an example of a suitable computing system environment 2800 in which one or aspects of the embodiments described herein can be implemented, although as made clear above, the computing system environment 2800 is only one example of a suitable computing environment and is not intended to suggest any limitation as to scope of use or functionality. Neither should the computing environment 2800 be interpreted as having any dependency or requirement relating to any one or combination of components illustrated in the example operating environment 2800.

With reference to FIG. 28, an example remote device for implementing one or more embodiments includes a general purpose computing device in the form of a computer 2810. Components of computer 2810 can include, but are not limited to, a processing unit 2820, a system memory 2830, and a system bus 2822 that couples various system components including the system memory to the processing unit 2820.

Computer 2810 typically includes a variety of computer readable media and can be any available media that can be accessed by computer 2810. The system memory 2830 can include computer storage media in the form of volatile and/or nonvolatile memory such as read only memory (ROM) and/or random access memory (RAM). By way of example, and not limitation, memory 2830 can also include an operating system, application programs, other program modules, and program data.

A user can enter commands and information into the computer 2810 through input devices 2840. A monitor or other type of display device is also connected to the system bus 2822 via an interface, such as output interface 2850. In addition to a monitor, computers can also include other peripheral output devices such as speakers and a printer, which can be connected through output interface 2850.

The computer 2810 can operate in a networked or distributed environment using logical connections to one or more other remote computers, such as remote computer 2870. The remote computer 2870 can be a personal computer, a server, a router, a network PC, a peer device or other common network node, or any other remote media consumption or transmission device, and can include any or all of the elements described above relative to the computer 2810. The logical connections depicted in FIG. 28 include a network 2872, such local area network (LAN) or a wide area network (WAN), but can also include other networks/buses. Such networking environments are commonplace in homes, offices, enterprise-wide computer networks, intranets and the Internet.

As mentioned above, while example embodiments have been described in connection with various computing devices and network architectures, the underlying concepts can be applied to any network system and any computing device or system in which it is desirable to employ disclosed and related systems, devices, and/or methods.

Also, there are multiple ways to implement the same or similar functionality, e.g., an appropriate API, tool kit, driver code, operating system, control, standalone or downloadable software object, etc. which enables applications and services to use disclosed and related systems, devices, methods, and/or functionality. Thus, embodiments herein are contemplated from the standpoint of an API (or other software object), as well as from a software or hardware object that implements one or more aspects of disclosed and related systems, devices, and/or methods as described herein. Thus, various embodiments described herein can have aspects that are wholly in hardware, partly in hardware and partly in software, as well as in software.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.

Those skilled in the art will recognize that it is common within the art to describe devices and/or processes in the fashion set forth herein, and thereafter use engineering practices to integrate such described devices and/or processes into systems. That is, at least a portion of the devices and/or processes described herein can be integrated into a system via a reasonable amount of experimentation. Those having skill in the art will recognize that a typical system can include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control device (e.g., feedback for sensing position and/or velocity; control devices for moving and/or adjusting parameters). A typical system can be implemented utilizing any suitable commercially available components, such as those typically found in data computing/communication and/or network computing/communication systems.

Various embodiments of the disclosed subject matter sometimes illustrate different components contained within, or connected with, other components. It is to be understood that such depicted architectures are merely example, and that, in fact, many other architectures can be implemented which achieve the same and/or equivalent functionality. In a conceptual sense, any arrangement of components to achieve the same and/or equivalent functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected,” “operably coupled,” “communicatively connected,” and/or “communicatively coupled,” to each other to achieve the desired functionality, and any two components capable of being so associated can also be viewed as being “operably couplable” or “communicatively couplable” to each other to achieve the desired functionality. Specific examples of operably couplable or communicatively couplable can include, but are not limited to, physically mateable and/or physically interacting components, wirelessly interactable and/or wirelessly interacting components, and/or logically interacting and/or logically interactable components.

With respect to substantially any plural and/or singular terms used herein, those having skill in the art can translate from the plural to the singular and/or from the singular to the plural as can be appropriate to the context and/or application. The various singular/plural permutations may be expressly set forth herein for the sake of clarity, without limitation.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes, but is not limited to,” etc.). It will be further understood by those skilled in the art that, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limit any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a” system having at least one of A, B, and C″ would include, but not be limited to, systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those skilled in the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub-ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be noted that various embodiments of the disclosed subject matter have been described herein for purposes of illustration, and that various modifications may be made without departing from the scope and spirit of the subject disclosure. Accordingly, the various embodiments disclosed herein are not intended to be limiting, with the true scope and spirit being indicated by the appended claims.

In addition, the words “example” and “non-limiting” are used herein to mean serving as an example, instance, or illustration. For the avoidance of doubt, the subject matter disclosed herein is not limited by such examples. Moreover, any aspect or design described herein as “an example,” “an illustration,” “example” and/or “non-limiting” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements, as described above.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. In addition, one or more components can reside within a process and/or thread of execution and a component can be localized on one computer and/or distributed between two or more computers.

Systems described herein can be described with respect to interaction between several components. It can be understood that such systems and components can include those components or specified sub-components, some of the specified components or sub-components, or portions thereof, and/or additional components, and various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and that any one or more middle component layers, such as a management layer, can be provided to communicatively couple to such sub-components in order to provide integrated functionality, as mentioned. Any components described herein can also interact with one or more other components not specifically described herein but generally known by those of skill in the art.

As mentioned, in view of the example systems described herein, methods that can be implemented in accordance with the described subject matter can be better appreciated with reference to the flowcharts of the various figures and vice versa. While for purposes of simplicity of explanation, the methods can be shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks can be required to implement the methods described hereinafter.

While the disclosed subject matter has been described in connection with the disclosed embodiments and the various figures, it is to be understood that other similar embodiments may be used or modifications and additions may be made to the described embodiments for performing the same function of the disclosed subject matter without deviating therefrom. Still further, multiple processing chips or multiple devices can share the performance of one or more functions described herein, and similarly, storage can be effected across a plurality of devices. In other instances, variations of process parameters (e.g., configuration, number of components, aggregation of components, process step timing and order, addition and/or deletion of process steps, addition of preprocessing and/or post-processing steps, etc.) can be made to further optimize the provided structures, devices and methods, as shown and described herein. In any event, the systems, structures and/or devices, as well as the associated methods described herein have many applications in various aspects of the disclosed subject matter, and so on. Accordingly, the subject disclosure should not be limited to any single embodiment, but rather should be construed in breadth, spirit and scope in accordance with the appended claims.

What is claimed is:

1. A method, comprising:
receiving, by a system including a processor, depth image information associated with a surface and arm positions, hand positions, or finger positions associated with a user and relative to the surface;
computing, by the system, a depth map based on the depth image information;
receiving, by the system, infrared image information associated with the arm positions, the hand positions, or the finger positions, wherein the infrared image information is registered with the depth image information;
computing, by the system, edge map information;
determining, with the system, at least one finger position of the finger positions relative to the surface, based on the depth map as constrained at least in part by the edge map information and anthropometric data related to at least one of the arm positions, the hand positions, or the finger positions relative to the surface; and
determining, by the system, that a touch of the surface has occurred by comparing a distance above the surface of the at least one finger position against a touch threshold.

2. The method of claim 1, wherein the computing the depth map further comprises:
computing, by the system, a depth mean and a depth standard deviation for a plurality of pixels associated with the surface based on the depth image information provided by a depth image sensor over a predetermined time period, wherein the depth map is determined relative to a position of the depth image sensor.

3. The method of claim 2, further comprising:
updating, by the system, the depth mean and the depth standard deviation for the plurality of pixels while the depth standard deviation remains less than a predetermined depth-dependent threshold.

4. The method of claim 1, wherein the computing the edge map information further comprises:
locating, by the system, candidate edge pixels associated with the at least one of the arm positions, the hand positions, or the finger positions, based on the infrared image information provided by an infrared image sensor.

5. The method of claim 4, wherein the locating the candidate edge pixels further comprises:
performing, by the system, an edge detection filter on the infrared image information and at least one of performing a gap-filling procedure on the edge map information or determining that at least one gap exists in the edge map information.

6. The method of claim 1, wherein the determining the at least one finger position further comprises:
segmenting, by the system, the depth map into a plurality of depth zones, wherein the plurality of depth zones are characterized by distance from the surface;
determining and discarding, by the system, error pixels in the depth map characterized by the distance from the surface exceeding an error threshold; and
determining, by the system, noise pixels in the depth map characterized by the distance from the surface being less than a noise threshold as belonging to a noise zone.

7. The method of claim 6, further comprising:
segmenting, by the system, the depth map into an above-noise zone; and
determining, by the system, above-noise pixels in the depth map characterized by the distance from the surface being greater than the noise threshold.

8. The method of claim 6, further comprising:
segmenting, by the system, the depth map into a high zone, a medium zone, and a low zone, wherein boundaries between the plurality of depth zones are derived from the anthropometric data related to the arm positions, the hand positions, or the finger positions.

9. The method of claim 6, wherein the determining the at least one finger position further comprises:
sequentially determining, by the system, pixels associated with the plurality of depth zones, wherein the pixels associated with the plurality of depth zones correspond to the at least one of the arm positions, the hand positions, or the finger positions relative to the surface.

10. The method of claim 9, wherein the sequentially determining the pixels associated with the plurality of depth zones comprises determining, by the system, pixels associated with the high zone, determining pixels associated with the medium zone, determining, by the system, pixels associated with the low zone, and determining, by the system, pixels associated with the noise zone, in order, wherein completion of a preceding step triggers a subsequent step.

11. The method of claim 9, wherein the sequentially determining the pixels associated with the plurality of depth zones further comprises:
identifying, by the system, the pixels associated with the plurality of depth zones in the high zone as arm pixels;
identifying, by the system, the pixels associated with the plurality of depth zones in the medium zone as hand pixels;
identifying, by the system, the pixels associated with the plurality of depth zones in the low zone as finger pixels; and
identifying, by the system, the pixels associated with the plurality of depth zones in the noise zone as fingertip pixels.

12. The method of claim 11, wherein the identifying the pixels associated with the plurality of depth zones in the high zone as the arm pixels comprises discriminating, by the system, based on the depth map.

13. The method of claim 11, wherein the identifying the pixels associated with the plurality of depth zones in the medium zone as the hand pixels comprises identifying, by the system, the pixels associated with the plurality of depth zones in the medium zone in a direction from the high zone to the low zone and discriminating, by the system, against surrounding pixels having high depth variance.

14. The method of claim 11, wherein the identifying the pixels associated with the plurality of depth zones in the low zone as the finger pixels comprises discriminating, by the system, based on the edge map information and comprises discriminating, by the system, against the pixels associated with the plurality of depth zones in the noise zone based on an identified discontinuity in the edge map information.

15. The method of claim 14, wherein the identifying the pixels associated with the plurality of depth zones in the noise zone as the fingertip pixels comprises identifying, by the system, pixels that do not extend beyond an edge of the edge map information and do not extend beyond a threshold distance from nearest ones of the hand pixels based on the anthropometric data.

16. The method of claim 15, further comprising:
determining, by the system, the at least one finger position based on the depth map as a result of at least one of the identified discontinuity in the edge map, identifying, by the system, pixels that do extend beyond the edge of the edge map information, or identifying, by the system, pixels that do extend beyond the threshold distance from the hand pixels based on the anthropometric data.

17. The method of claim 15, wherein the determining the at least one finger position of the finger positions further comprises:
adding, by the system, the finger tip pixels to connected ones of the finger pixels;
determining, by the system, a maximum distance from the nearest ones of the hand pixels to connected ones of the finger tip pixels;
determining, by the system, a finger-tip pixel of the finger tip pixels having the maximum distance; and
assigning, by the system, a position of the finger-tip pixel as the at least one finger position of the finger positions.

18. The method of claim 17, wherein the determining that the touch of the surface has occurred further comprises:
averaging, by the system, the distance above the surface of a subset of the finger tip pixels nearest the finger-tip pixel of the finger tip pixels having the maximum distance; and
determining, by the system, the touch threshold based in part on a width of a finger associated with the user derived from at least a subset of the finger pixels.

19. The method of claim 1, further comprising:
receiving, by the system, the depth image information comprising time of flight depth image information and receiving the infrared image information comprising reflected infrared light information as a result of unstructured infrared illumination on the surface as provided by a single sensor.

20. The method of claim 1, further comprising:
generating, by the system, user interface information for display onto the surface that corresponds to the touch of the surface.

21. The method of claim 1, wherein the computing the edge map information comprises computing the edge map information based at least in part on at least one of the depth image information or the infrared image information.

22. A non-transitory computer readable storage medium comprising computer executable components that, in response to execution by a computing device, cause the computing a device to execute or facilitate execution of the computer executable components, the computer executable components comprising:
a depth map component configured to compute a depth map based on depth image information associated with a surface and arm positions, hand positions, or finger positions associated with a user and relative to the surface;
a edge map component configured to compute edge map information associated with the arm positions, the hand positions, or the finger positions, wherein the infrared image information is registered with the depth image information;
a finger identification component configured to determine at least one finger position of the finger positions relative to the surface, based on the depth map as constrained at least in part by the edge map information and anthropometric data related to at least one of the arm positions, the hand positions, or the finger positions relative to the surface;
a touch tracking component configured to determine that a touch of the surface has occurred by comparing a distance above the surface of the at least one finger position against a touch threshold; and
a user interface component configured to generate user interface information for display onto the surface that corresponds to the touch of the surface.

23. A system, comprising:
a memory to store computer-executable components; and
a processor communicatively coupled to the memory that facilitates execution of the computer-executable components, the computer-executable components, comprising:
a depth map component configured to compute a depth map based on depth image information associated with a surface and arm positions, hand positions, or finger positions associated with a user and relative to the surface;
an edge map component configured to compute edge map information associated with the arm positions, the hand positions, or the finger positions, wherein the infrared image information is registered with the depth image information;
a finger identification component configured to determine at least one finger position of the finger positions relative to the surface, based on the depth map as constrained at least in part by the edge map information and anthropometric data related to at least one of the arm positions, the hand positions, or the finger positions relative to the surface; and
a touch tracking component configured to determine that a touch of the surface has occurred by comparing a distance above the surface of the at least one finger position against a touch threshold.

24. The system of claim 23, further comprising:
a depth image sensor configured to provide the depth image information;
an infrared image sensor configured to provide the infrared image information; and
a user interface component configured to generate user interface information for display onto the surface that corresponds to the touch of the surface.
